(19) United States
(12) Patent Application Publication
(10) Pub. No.: US 2025/0056586 A1
(43) Pub. Date: Feb. 13, 2025

(54) TECHNIQUES FOR AIRCRAFT-TO-EVERYTHING COMMUNICATIONS

(71) Applicant: QUALCOMM Incorporated, San Diego, CA (US)

(72) Inventors: Umesh PHUYAL, San Diego, CA (US); Le LIU, San Jose, CA (US); Sunghoon KIM, San Diego, CA (US); Peter GAAL, San Diego, CA (US); Alberto RICO ALVARINO, San Diego, CA (US)

(21) Appl. No.: 18/740,284

(22) Filed: Jun. 11, 2024

Related U.S. Application Data
(60) Provisional application No. 63/518,688, filed on Aug. 10, 2023.

(51) Int. Cl. H04W 72/40; H04W 72/51

(52) U.S. Cl. CPC H04W 72/40; H04W 72/51

(57) ABSTRACT

Methods, systems, and devices for wireless communication are described that provide for indicating device capabilities and/or device type or category, such as UE-to-UE direct communications via a PC5 interface, for aircraft-to-everything (A2X) communications. An A2X configuration may be provided that allows aerial UEs, such as unmanned aerial vehicles (UAVs) to indicate support for specific A2X functions. A2X functionalities may indicate support for transmit and receive communications, receive-only communications, or transmit-only communications. UE capability for A2X communications may be provided using one or more A2X-specific capability bits in a vehicle-to-everything (V2X) capability report or a sidelink capability report, that may individually or jointly indicate support for broadcast remote identification (BRID) transmissions, detect-and-avoid (DAA) transmissions, both, and/or other A2X communications. Further, a UAV may report one or more access link capabilities related to UAVs.

### CROSS REFERENCE

The present Application for Patent claims the benefit of U.S. Provisional Patent Application No. 63/518,688 by PHUYAL et al., entitled “TECHNIQUES FOR AIRCRAFT-TO-EVERYTHING COMMUNICATIONS,” filed Aug. 10, 2023, assigned to the assignee hereof, and expressly incorporated by reference herein.

### FIELD OF TECHNOLOGY

The following relates to wireless communication, including techniques for aircraft-to-everything communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some deployments, wireless communications systems may support communications between ground-based wireless devices (e.g., UEs, network entities) and aerial wireless devices (e.g., unmanned aerial vehicles (UAVs)). Such devices may perform different types of communications intended for various receivers. For example, a UAV may transmit different messages intended for ground-based devices or other UAVs. Efficient techniques for communicating different messages from aerial wireless devices (e.g., UAVs) may help enhance overall network efficiency and reliability.

### SUMMARY

The described techniques relate to improved methods, systems, devices, and apparatuses that support techniques for aircraft-to-everything (A2X) communications. For example, the described techniques provide for indicating sidelink capabilities (e.g., user equipment (UE) to UE direct communications, such as via a PC5 interface) for A2X communications (e.g., aircraft-to-aircraft communications, aircraft-to-ground communications, or any combinations thereof). In some aspects, an A2X configuration may be provided that is separate from a vehicle-to-everything (V2X) structure, that allows aerial UEs (e.g., unmanned aerial vehicles (UAVs)) to indicate support for specific A2X functions. In other aspects, A2X functionalities may be dependent on UE support of V2X capabilities, and signaling of A2X capabilities may allow for a subset of V2X capabilities to be supported at the UE (e.g., an aerial UE may report that the aerial UE is a receive-only UE and does not provide any parameters for transmitting via sidelink, or an aerial UE may be a transmit-only UE that does not receive A2X communications). In some cases, a UE capability for A2X communications may be provided appending one or more A2X-specific capability bits to one or more V2X capability reports. In further aspects, an aerial UE may provide a limited set of A2X-specific capability indications, that may individually or jointly indicate support for A2X-specific capability for services such as broadcast remote ID (BRID) transmission and/or detect-and-avoid (DAA) communications. BRID communications and DAA communications are examples of A2X communications. Additionally, or alternatively, an aerial UE may report one or more access link (e.g., Uu link) capabilities, such as by a capability bit that indicates support of all aerial functions, or an indication of one or more supported height-dependent (e.g., altitude dependent) or flight path indication functions.

A method for wireless communication by an aerial UE is described. The method may include transmitting a capability indication of the aerial UE, where the capability indication indicates one or more supported functions that use A2X communication via a sidelink connection of the aerial UE and transmitting or receiving one or more A2X transmissions using at least a subset of a resource allocation that is determined from a set of sidelink resources for A2X communications.

A UE for wireless communication is described. The UE may include one or more memories storing processor executable code, and one or more processors coupled with the one or more memories. The one or more processors may individually or collectively operable to execute the code to cause the UE to transmit a capability indication of the UE, where the capability indication indicates one or more supported functions that use A2X communication via a sidelink connection of the UE and transmit or receive one or more A2X transmissions using at least a subset of a resource allocation that is determined from a set of sidelink resources for A2X communications.

Another UE for wireless communication is described. The UE may include means for transmitting a capability indication of the UE, where the capability indication indicates one or more supported functions that use A2X communication via a sidelink connection of the UE and means for transmitting or receiving one or more A2X transmissions using at least a subset of a resource allocation that is determined from a set of sidelink resources for A2X communications.

A non-transitory computer-readable medium storing code for wireless communication is described. The code may include instructions executable by a processor to transmit a capability indication of a UE, where the capability indication indicates one or more supported functions that use A2X communication via a sidelink connection of the UE and transmit or receive one or more A2X transmissions using at least a subset of a resource allocation that is determined from a set of sidelink resources for A2X communications.

In some examples of the method, UEs, and non-transitory computer-readable medium described herein, transmitting the capability indication may include operations, features, means, or instructions for transmitting a set of supported A2X parameters that are separate from a different set of V2X communication parameters for sidelink communications. Some examples of the method, UEs, and non-transitory computer-readable medium described herein may further include operations, features, means, or instructions for transmitting a capability indication for sidelink communications, where the A2X communication is dependent on support of sidelink communications at the UE.

In some examples of the method, UEs, and non-transitory computer-readable medium described herein, transmitting the capability indication may include operations, features, means, or instructions for transmitting one or more A2X capability parameters that indicate support for one or more of BRID communications or DAA communications.

In some examples of the method, UEs, and non-transitory computer-readable medium described herein, transmitting the capability indication may include operations, features, means, or instructions for transmitting a capability indication for a subset of sidelink communications, that indicates the UE supports less than all sidelink communication capabilities. In some examples of the method, UEs, and non-transitory computer-readable medium described herein, the capability indication indicates the UE supports receive-only functions of A2X communications. In some examples of the method, aerial UEs, and non-transitory computer-readable medium described herein, the capability indication indicates the UE supports transmit-only functions of A2X communications. In some examples of the method, UEs, and non-transitory computer-readable medium described herein, the capability indication indicates the UE supports channel sensing for a sidelink channel, and supports transmit-only functions of A2X communications.

In some examples of the method, UEs, and non-transitory computer-readable medium described herein, the capability indication may be provided in one or more A2X capability bits that are appended to one or more sidelink capability messages. In some examples of the method, UEs, and non-transitory computer-readable medium described herein, transmitting the capability indication may include operations, features, means, or instructions for transmitting the capability indication as a differential capability from an associated V2X communication capability. In some examples of the method, UEs, and non-transitory computer-readable medium described herein, the capability indication includes separate indications of support for BRID communications and DAA communications. In some examples, the separate indications are independent of V2X communications parameters. In some examples of the method, UEs, and non-transitory computer-readable medium described herein, the capability indication includes a single indication of support for BRID communications and DAA communications. In some examples, the single indication is independent of V2X communications parameters. In some examples, the single indication may be a two-bit field that indicates support for BRID communications, DAA communications, or both.

Some examples of the method, UEs, and non-transitory computer-readable medium described herein may further include operations, features, means, or instructions for transmitting an indication to a network entity of one or more supported UE functions that use an access link with the network entity. In some examples of the method, UEs, and non-transitory computer-readable medium described herein, the one or more supported UE functions include one or more of height-dependent parameter reporting, joint measurement and height-dependent parameter reporting, flight path parameter reporting, or any combinations thereof.

In some examples of the method, UEs, and non-transitory computer-readable medium described herein, the one or more A2X transmissions include one or more of a BRID or a DAA transmission.

In some examples of the method, UEs, and non-transitory computer-readable medium described herein, the capability indication indicates a list of one or more A2X sidelink bands or sidelink band combinations where one or more A2X services are supported by the UE.

A method for wireless communication by a UE is described. The method may include receiving a capability indication from a UE, where the capability indication indicates one or more supported functions that use A2X communication of the UE and transmitting or receiving one or more A2X transmissions using at least a subset of a resource allocation of sidelink resources for A2X communications.

A UE for wireless communication is described. The UE may include one or more memories storing processor executable code, and one or more processors coupled with the one or more memories. The one or more processors may individually or collectively operable to execute the code to cause the UE to receive a capability indication from an aerial UE, where the capability indication indicates one or more supported functions that use A2X communication of the aerial UE and transmit or receive one or more A2X transmissions using at least a subset of a resource allocation of sidelink resources for A2X communications.

Another UE for wireless communication is described. The UE may include means for receiving a capability indication from an aerial UE, where the capability indication indicates one or more supported functions that use A2X communication of the aerial UE and means for transmitting or receiving one or more A2X transmissions using at least a subset of a resource allocation of sidelink resources for A2X communications.

A non-transitory computer-readable medium storing code for wireless communication is described. The code may include instructions executable by a processor to receive a capability indication from an aerial UE, where the capability indication indicates one or more supported functions that use A2X communication of the aerial UE and transmit or receive one or more A2X transmissions using at least a subset of a resource allocation of sidelink resources for A2X communications.

In some examples of the method, UEs, and non-transitory computer-readable medium described herein, the capability indication indicates a set of supported A2X parameters that are separate from a different set of V2X communication parameters for sidelink communications, that are independent of V2X communications parameters, that are dependent on one or more V2X communications parameters, that indicates the aerial UE supports less than all V2X communication capabilities, that indicates the aerial UE supports receive-only functions of A2X communications, that indicates the aerial UE supports transmit-only functions of A2X communications, or that indicates the aerial UE supports only channel sensing receptions for a sidelink channel.

In some examples of the method, UEs, and non-transitory computer-readable medium described herein, the capability indication may be provided in one or more A2X capability bits that are appended to one or more sidelink capability messages. In some examples of the method, UEs, and non-transitory computer-readable medium described herein, the capability indication may be a differential capability from an associated V2X communication capability. In some examples of the method, UEs, and non-transitory computer-readable medium described herein, the capability indication includes separate indications of support for BRID communications and DAA communications. In some examples, the separate indications are independent of V2X communications parameters. In some examples of the method, UEs, and non-transitory computer-readable medium described herein, the capability indication includes a single indication of support for BRID communications and DAA communications. In some examples, the single indication is independent of V2X communications parameters. In some examples, the single indication may be a two-bit field that indicates support for BRID communications, DAA communications, or both.

In some examples of the method, UEs, and non-transitory computer-readable medium described herein, the one or more A2X transmissions include one or more of a BRID or a DAA transmission.

In some examples of the method, UEs, and non-transitory computer-readable medium described herein, the capability indication indicates a list of one or more A2X sidelink bands or sidelink band combinations where one or more A2X services are supported by the UE.

A method for wireless communication by a network entity is described. The method may include receiving a capability indication from an aerial UE, where the capability indication indicates one or more supported functions that use A2X communication of the aerial UE and transmitting, to the aerial UE and one or more other UEs, a resource allocation for a set of sidelink resources for A2X communications.

A network entity for wireless communication is described. The network entity may include one or more memories storing processor executable code, and one or more processors coupled with the one or more memories. The one or more processors may individually or collectively operable to execute the code to cause the network entity to receive a capability indication from an aerial UE, where the capability indication indicates one or more supported functions that use A2X communication of the aerial UE and transmit, to the aerial UE and one or more other UEs, a resource allocation for a set of sidelink resources for A2X communications.

Another network entity for wireless communication is described. The network entity may include means for receiving a capability indication from an aerial UE, where the capability indication indicates one or more supported functions that use A2X communication of the aerial UE and means for transmitting, to the aerial UE and one or more other UEs, a resource allocation for a set of sidelink resources for A2X communications.

A non-transitory computer-readable medium storing code for wireless communication is described. The code may include instructions executable by a processor to receive a capability indication from an aerial UE, where the capability indication indicates one or more supported functions that use A2X communication of the aerial UE and transmit, to the aerial UE and one or more other UEs, a resource allocation for a set of sidelink resources for A2X communications.

In some examples of the method, network entities, and non-transitory computer-readable medium described herein, receiving the capability indication may include operations, features, means, or instructions for receiving, from the aerial UE, a set of supported A2X parameters that are separate from a different set of V2X communication parameters for sidelink communications. Some examples of the method, network entities, and non-transitory computer-readable medium described herein may further include operations, features, means, or instructions for receiving, from the aerial UE, a capability indication for sidelink communications, where the A2X communication is dependent on support of sidelink communications at the aerial UE. In some examples of the method, network entities, and non-transitory computer-readable medium described herein, receiving the capability indication may include operations, features, means, or instructions for receiving, from the aerial UE, one or more A2X capability parameters that indicate support, where the one or more A2X capability parameters are independent of V2X communications parameters.

In some examples of the method, network entities, and non-transitory computer-readable medium described herein, receiving the capability indication may include operations, features, means, or instructions for receiving, from the aerial UE, a capability indication for a subset of V2X communications, that indicates the aerial UE supports less than all V2X communication capabilities. In some examples of the method, network entities, and non-transitory computer-readable medium described herein, the capability indication indicates the aerial UE supports receive-only functions of A2X communications. In some examples of the method, network entities, and non-transitory computer-readable medium described herein, the capability indication indicates the aerial UE supports transmit-only functions of A2X communications. In some examples of the method, network entities, and non-transitory computer-readable medium described herein, the capability indication indicates the aerial UE supports channel sensing for a sidelink channel, and supports transmit-only functions of A2X communications.

In some examples of the method, network entities, and non-transitory computer-readable medium described herein, the capability indication may be provided in one or more A2X capability bits that are appended to one or more sidelink capability messages. In some examples of the method, network entities, and non-transitory computer-readable medium described herein, receiving the capability indication may include operations, features, means, or instructions for receiving, from the aerial UE, the capability indication as a differential capability from an associated V2X communication capability.

In some examples of the method, network entities, and non-transitory computer-readable medium described herein, the capability indication includes separate indications of support for BRID communications and DAA communications. In some examples, the separate indications are independent of V2X communications parameters. In some examples of the method, network entities, and non-transitory computer-readable medium described herein, the capability indication includes a single indication of support for BRID communications and DAA communications. In some examples, the single indication is independent of V2X communications parameters. In some examples, the single indication may be a two-bit field that indicates support for BRID communications, DAA communications, or both.

Some examples of the method, network entities, and non-transitory computer-readable medium described herein may further include operations, features, means, or instructions for receiving, from the aerial UE, an indication of one or more supported aerial UE functions that use an access link with the network entity. In some examples of the method, network entities, and non-transitory computer-readable medium described herein, the one or more aerial UE functions include one or more of height-dependent parameter reporting, joint measurement and height-dependent parameter reporting, flight path parameter reporting, or any combinations thereof.

### BRIEF DESCRIPTION OF THE DRAWINGS

FIG. 1 shows an example of a wireless communications system that supports aircraft-to-everything (A2X) sidelink communications in accordance with one or more aspects of the present disclosure.

FIG. 2 shows an example of a portion of a wireless communications system that supports techniques for A2X communications in accordance with one or more aspects of the present disclosure.

FIGS. 3 and 4 show examples of process flows that support techniques for A2X communications in accordance with one or more aspects of the present disclosure.

FIGS. 5 and 6 show block diagrams of devices that support techniques for A2X communications in accordance with one or more aspects of the present disclosure.

FIG. 7 shows a block diagram of a communications manager that supports techniques for A2X communications in accordance with one or more aspects of the present disclosure.

FIG. 8 shows a diagram of a system including a device that supports techniques for A2X communications in accordance with one or more aspects of the present disclosure.

FIGS. 9 and 10 show block diagrams of devices that support techniques for A2X communications in accordance with one or more aspects of the present disclosure.

FIG. 11 shows a block diagram of a communications manager that supports techniques for A2X communications in accordance with one or more aspects of the present disclosure.

FIG. 12 shows a diagram of a system including a device that supports techniques for A2X communications in accordance with one or more aspects of the present disclosure.

FIGS. 13 through 24 show flowcharts illustrating methods that support techniques for A2X communications in accordance with one or more aspects of the present disclosure.

### DETAILED DESCRIPTION

A wireless communications system may support communications between terrestrial wireless devices (e.g., user equipment (UEs), network entities) and aerial vehicles such as unmanned aerial vehicles (UAVs) or other unmanned aerial systems (UASs). For example, the wireless communications system may support UAV-to-UAV communications and UAV-to-terrestrial UE communications. Some types of UAV-to-UAV communications may include detect-and-avoid (DAA) messages, intended to assist UAVs in avoiding collisions with each other. Such DAA messages may be similar to safety messages used in vehicle-to-everything (V2X) communications as the UAVs may broadcast information about their position, headings, and other location information. Some types of UAV-to-terrestrial UE communications may include broadcast remote identifier (BRID) messages that may also indicate information regarding the position and heading of a UAV and flight information for remote identification. In some examples, a terrestrial UE may be associated with a user (e.g., a law enforcement agent) on the ground.

In this way, the UAV-to-UAV and UAV-to-terrestrial UE communications types may be intended for specific receivers. For example, DAA messages may be intended for other flying UAVs, where a BRID message may be intended for flying UAVs or ground-based devices (e.g., UAV control devices, law-enforcement officers, other agencies on the ground, etc.). Further, in comparison to vehicles that may implement V2X communications, some UAVs may communicate according to specific UAV functionalities, such as for only BRID or DAA communications, and thus may not be required to support some functions of V2X communications (e.g., support of sidelink reception, support for sidelink mode 1 or mode 2 communications, support for sidelink synchronization procedures, or support for sidelink measurement reports). As such, it may be useful to have a UE capability indication for aircraft-to-everything (A2X) communications (e.g., UAV-to-UAV or UAV-to-terrestrial UE communications) such that an A2X device may communicate in accordance with A2X functions that are relevant to the device. For example, a low-cost and low-complexity UAV may provide BRID and DAA communications, but no other data communications. BRID communications and DAA communications are examples of A2X communications. Techniques as discussed herein provide that A2X capable UEs may provide information about the device capability and/or device type or category indicating the supported A2X functions, and communicate with other nodes in accordance with the reported capability.

In some examples, a dedicated receiving device that only monitors for BRID messages may receive and decode BRID messages based on an indicated capability for receive-only communications, and a low-cost quad-copter UE may benefit from skipping decoding of BRID messages broadcasted by other UAVs but may transmit DAA messages. As such, by allowing UE capability indications for A2X communications, A2X devices may support fewer functions than V2X devices and have flexibility for the types of A2X communications that are supported. Such techniques may result in power savings, lower cost devices, improved resource utilization, and reduce signaling overhead, among other benefits.

In accordance with various aspects, described techniques provide for indicating sidelink capabilities (e.g., UE-to-UE direct communications, such as via a PC5 interface) for A2X communications. In some aspects, an A2X configuration may be provided that is separate from a V2X configuration structure, that allows aerial UEs (e.g., UAVs) to indicate support for specific A2X functions. In other aspects, A2X functionalities may be dependent on UE support of V2X capabilities, and signaling of A2X capabilities may allow for a subset of V2X capabilities to be supported at the UE. In some cases, a UE capability for A2X communications may be provided using one or more A2X-specific capability bits that are appended to one or more sidelink (e.g., V2X) capability reports. In further aspects, an aerial UE may provide a limited set of A2X-specific capability indications, that may individually or jointly indicate support for BRID communications, DAA communications, or any combinations thereof.

Additionally, or alternatively, an aerial UE may report one or more access link (e.g., Uu link) capabilities, such as by a capability bit that indicates support of all aerial functions, or an indication of one or more supported height-dependent (e.g., altitude-dependent) or flight path indication functions.

Aspects of the disclosure are initially described in the context of wireless communications systems. Aspects of the disclosure are further illustrated by and described with reference to process flows, apparatus diagrams, system diagrams, and flowcharts that relate to techniques for A2X communications.

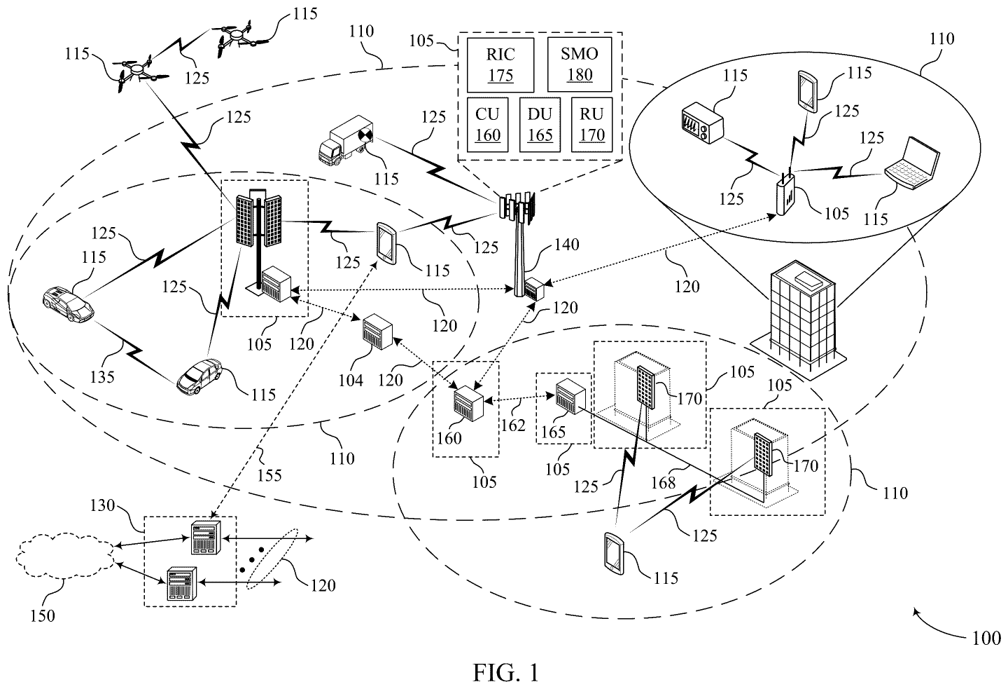

FIG. 1 shows an example of a wireless communications system 100 that supports techniques for A2X communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 (e.g., including UAV UEs 115) may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support A2X communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115 or UAV UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both. In further examples, aerial UEs 115 may communicate using A2X communications. A2X communications may be similar, in some cases, to V2X communications and allow aircraft-to-aircraft communications, aircraft-to-ground communications, or any combinations thereof. In some examples, UAV UE 115 may signal information related to BRID, DAA, or any other information relevant to an A2X system via sidelink or V2X communications.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support communications between terrestrial wireless devices (e.g., UEs 115, network entities 105) and aerial vehicles such as UAV UEs 115 or other unmanned aerial systems. For example, the wireless communications system may support UAV-to-UAV communications (between UAV UEs 115 via a communication link 125) and UAV-to-terrestrial UE communications. Some types of UAV-to-UAV communications may include DAA messages, intended to assist UAV UEs 115 in avoiding collisions with each other. Such DAA messages may broadcast information about a UAV's position, headings, and other location information. Some types of UAV-to-terrestrial UE communications may include BRID messages that may also indicate information regarding the position and heading of a UAV UE 115 and flight information for remote identification. In some examples, the terrestrial UE 115 may be associated with a user (e.g., a law enforcement agent) on the ground.

In some aspects, described techniques provide for indicating sidelink capabilities (e.g., UE-to-UE direct communications, such as via a PC5 interface) for A2X communications (e.g., aircraft-to-aircraft communications, aircraft-to-ground communications, or any combinations thereof). In some aspects, an A2X configuration may be provided that is separate from a V2X configuration, that allows aerial UEs 115 (e.g., UAV UEs 115) to indicate support for specific A2X functions. In some aspects, A2X functionalities may be dependent on UE 115 support of V2X capabilities, and signaling of A2X capabilities may allow for a subset of V2X capabilities to be supported at the UE 115 (e.g., a UAV UE 115 may report that it supports receive-only or transmit-only communications). In some cases, a UE 115 capability for A2X communications may be provided using one or more A2X-specific capability bits to one or more V2X capability reports. In further aspects, a UAV UE 115 may provide a limited set of A2X-specific capability indications, that may individually or jointly indicate support for BRID transmission and DAA communications. Additionally, or alternatively, a UAV UE 115 may report one or more access link (e.g., Uu link) capabilities, such as by a capability bit that indicates support of all aerial functions, or an indication of one or more supported height-dependent (e.g., altitude-dependent) or flight path indication functions.

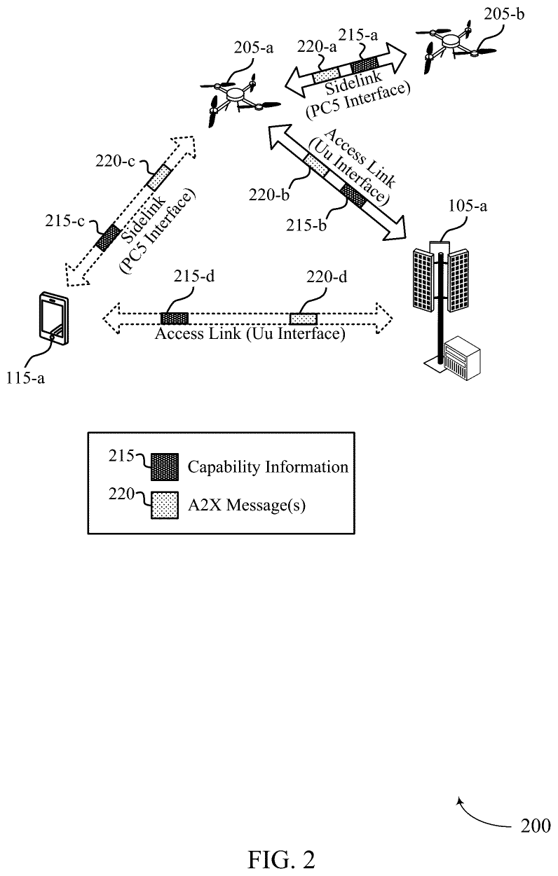

FIG. 2 shows an example of a wireless communications system 200 that supports A2X communications in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a, a network entity 105-a, a first UAV 205-a, and a second UAV 205-b, which may be examples of corresponding devices described herein. The UE 115-a and the network entity 105-a may be terrestrial wireless devices (e.g., on the ground), and the UAVs 205 may be examples of drones or other aerial vehicles, and are also examples of UEs 115 as discussed herein.

The wireless communications system 200 may support communications between the UE 115-a, the network entity 105-a, and the UAVs 205 via respective communication links, which may be examples of communication links 125 described herein with reference to FIG. 1. For example, the UE 115-a and the network entity 105-a may optionally perform uplink and downlink communications via a Uu link, and the first UAV 205-a and the network entity 105-a may communicate via a Uu link. In addition, the UE 115-a optionally may communicate with the first UAV 205-a via a sidelink, and the first UAV 205-a and the second UAV 205-b may communicate via a sidelink. In this way, the wireless communications system 200 may support UAV-to-UAV communications and UAV-to-terrestrial UE communications.

Some types of UAV-to-UAV communications may include DAA messages, intended to assist the UAVs 205 in avoiding collisions with each other. Such DAA messages may broadcast information about a UAV's position, headings, and other location information. DAA messages may provide situational awareness, alerting, and avoidance used to maintain safe beyond visual line of sight (BVLOS) operation of the UAVs 205. In addition, different variants or types of the DAA messages may correspond to different requirements of the UAVs 205. For example, a broadcast DAA may indicate a location, a heading, a time, and other information (e.g., location and direction information) broadcast periodically by the UAVs 205. A DAA deconfliction message may be broadcast or unicast and may indicate data different from (or additional to) the information indicated in the broadcast DAA message.

Some types of UAV-to-terrestrial UE communications (e.g., from first UAV 205-a to UE 115-a, network entity 105-a, or both) may include BRID messages that may indicate a UAS ID, UA type, UAS ID type, position and heading information of a UAV 205, and flight information for remote identification. In some examples, the UE 115-a (e.g., a terrestrial UE 115) may be associated with a user (e.g., a law enforcement agent) on the ground. A BRID message may indicate a UAS ID, a UAS ID type, and an unmanned aircraft (UA) type. For example, the UAS ID may indicate a serial number (e.g., expressed in a CTA-2063-A serial number format), a registration ID (e.g., if a Civil Aviation Authority (CAA) provides a method of registering the UAS, the number is provided by the CAA or an authorized representative), and a UAS traffic management (UTM) (e.g., a universal unique ID (UUID)), which may be a UTM-provided unique ID traceable to the registration ID that may act as a session ID to protect exposure of operationally sensitive information. The UAS ID type may indicate the serial number, the registration ID, or the UTM UUID. The UA type may help in inferring performance, speed, and duration of UAV flights (e.g., a fixed wing aircraft may generally fly in a forward direction as compared to a multi-rotor aircraft), differentiate aircraft types without sharing operationally sensitive information, and correlate visual observations with received data.

In accordance with aspects provided herein, BRID messages and/or DAA messages may be referred to as A2X messages 220. In some examples, any other information relevant to an A2X system may be included in an A2X message 220. In the example, of FIG. 2, the second UAV 205-b and the first UAV 205-a may communicate a first A2X message 220-a, the first UAV 205-a and the network entity 105-a may communicate a second A2X message 220-b (e.g., that may include information from the first A2X message 220-a), and the first UAV 205-a and the UE 115-a may communicate a third A2X message 220-c (e.g., that may include information from the first A2X message 220-a). In some cases, the second A2X message 220-b and the third A2X message 220-c may be a same message that is broadcast by the first UAV 205-a. In some aspects, the types of information in an A2X message 220 may be based on supported functionalities of the UE 115-a or UAVs 205, that may be indicated in a capability information message 215.

In some examples, the second UAV 205-b may transmit a first capability information message 215-a. Further, the first UAV 205-a may transmit, to the network entity 105-a, a second capability information message 215-b, and may transmit a third capability information message 215-c to the UE 115-a. In some cases, the second capability information message 215-b and the third capability information message 215-c may be a same capability information message 215 that indicates A2X functionalities supported by the first UAV 205-a. In some aspects, the indicated A2X configuration may be separate from a V2X configuration, that allows UAVs 205, UE 115-a, or any combinations thereof, to indicate support for specific A2X functions. As discussed herein, in some cases A2X functionalities may be dependent on UAV 205 or UE 115-a support of V2X capabilities, and signaling of A2X capabilities may allow for a subset of V2X capabilities to be supported at the UAVs 205 or UE 115-a (e.g., the first UAV 205-a may report that it supports transmit-only communications, and the UE 115-a may report that is supports receive-only communications).

As discussed herein, in some aspects the capability information messages 215 may provide that A2X communications support the same functionalities as V2X communications, along with one or more additional functionalities for A2X communications (e.g., BRID and DAA communications and/or any other information relevant to an A2X system). In other aspects, the capability information messages 215 may provide that A2X communications support the fewer functionalities than are supported for V2X communications. Such techniques may allow for enhanced flexibility for UAVs 205 to have lower complexity and cost. For example, V2X communications may use one or more parameters that may not be necessary for some A2X communications (e.g., one or more of: commSupportedBands-r12, commSimultaneousTx-r12, discSupportedBands-r12, discScheduledResourceAlloc-r12, disc-UE-SelectedResourceAlloc-r12, disc-SLSS-r12, discSupportedProc-r12, commMultipleTx-r13, discInterFreqTx-r13, discPeriodicSLSS-r13, discSysInfoReporting-r13, zoneBasedPoolSelection-r14, accessStratumReleaseSidelink-r16, relayUE-Operation-L2-r17, remoteUE-Operation-L2-r17, remoteUE-PathSwitchToldleInactiveRelay-r17, outOfOrderDeliverySidelink-r16, am-WithLongSN-Sidelink-r16, um-WithLongSN-Sidelink-r16, drx-OnSidelink-r17, lcp-RestrictioSidelink-r16, logicalChannelSR-DelayTimerSidelink-r16, multipleSR-ConfigurationsSidelink-r16, multipelConfiguredGrantsSidelink-r16, among others). Further, V2X communications may provide that a device is to provide support for various capabilities that may not be necessary for some A2X communications (e.g., if a UE supports sidelink communication on at least one band, the UE shall support: sidelink communication transmission based on UE autonomous resource selection, network device scheduled resource allocation, ProSe Per Packet Priority (PPPP) handling, out of coverage sidelink discovery, 16 sidelink processes (8 for V2X) for reception of SL-SCH. Further the UE may optionally indicate support of PO parameters for open loop power control, supported band combinations, and/or per-band configuration of certain parameters, sidelink transmission/reception per band, cross-carrier scheduling per band, transmission mode 2 partial sensing per frame structure, sidelink feedback channel support per frame structure, inter-UE coordination support per frame structure, among others).

As discussed herein, in various aspects, support for various A2X functionalities may be indicated in one or more capability information messages 215 between UAVs 205, UE 115-a, network entity 105-a, or any combinations thereof. In some cases, one or more of the capability information messages 215 may correspond to V2X capability information messages with one or more additional structures to support A2X (e.g., to indicate support for BRID communications, DAA communications, both, or any other information relevant to an A2X system). In other cases, one or more A2X functionalities may be dependent on support of V2X capabilities. In further cases, one or more A2X related parameters may be provided independently of any V2X parameters. In further cases, capability information for V2X communications may or may not be transmitted by UAVs 205 (e.g., indications for one or more of the following which are needed to be supported for V2X may not be needed to be supported in order to support A2X: sl-Reception-r16 (to indicate sidelink receive support), sl-TransmissionModel-r16 (to indicate support of licensed spectrum sidelink mode 1 communications), sl-TransmissionMode2-r16 (to indicate support of licensed spectrum sidelink mode 2 communications), sync-Sidelink-r16 (to indicate support for sidelink synchronization), congestionControlSidelink-r16 (to indicate support for sidelink congestion control), psfch-FormatZeroSidelink-r16 (to indicate support for a certain feedback channel format), csi-ReportSidelink-r16 (to indicate support for channel state information measurement reporting), sl-openLoopPC-RSRP-ReportSidelink-r16 (to indicate support for certain open loop power control techniques)).

In accordance with some aspects, the capability information message 215 may indicate A2X communications, and that the UAV 205 or UE 115-a may be a transmit-only device, a receive-only device, or a sensing and transmit-only device. For example, the UE 115-a may be a receive-only A2X device used by a law enforcement unit at the ground, or while flying, to collect information on all drones around the UE 115-a. Such a device only needs to receive BRID transmissions from UAVs 205, and does not need to transmit anything to the UAVs. For such a UE 115-a, for example, transmitter functionalities may not be needed and complexity and cost of the UE 115-a can be reduced. Further, signaling overhead may be reduced because several V2X parameters may not need to be transmitted (e.g., sl-TransmissionModel-r16, sl-TransmissionMode2-r16, etc., needed for V2X may not be transmitted in the A2X capability information message 215-d or the A2X message 220-d).

In other examples, a UAV 205 may be a transmit-only device. For example, a UAV 205 may only broadcast BRID information, and does not need to receive anything from other UAVs 205 or UEs 115. In some examples, a transmit-only UAV 205 may operate in sidelink transmission mode 2 (e.g., where UEs select sidelink resources from a sidelink resource pool for sidelink messages). In some cases, a sidelink mode 2 resource pool can be configured or preconfigured to allow full sensing only, partial sensing only, random selection only, or any combination(s) thereof. In such cases, a UAV 205 in this mode may provide an indication that the UAV 205 supports random selection only and may do random resource selection based on such a configuration, for example, and may avoid supporting even partial or full sensing that may be used on other mode 2 configurations.

In further examples, a UAV 205 may operate in sidelink transmission mode 2 and use channel sensing to confirm that the channel is available for a random resource selection before transmitting a message. In such cases, a capability information message 215 may indicate that the device has a capability of performing channel sensing for resource selection but no other receive functions. In accordance with various aspects, the A2X capability information messages 215 may indicate A2X functionality as part of one or more V2X messages. In some cases, one or more other V2X parameters may not be included in the message to help reduce signaling overhead and power consumption.

In some examples, the capability information messages 215 may provide a capability differentiation for a UAV 205 or UE 115-a that can support both V2X and A2X. For example, UE 115-a may support both V2X and A2X, and one or more A2X-specific capability bits may be included with a corresponding to per-UE V2X or sidelink capability indication (e.g., PDCP out-of-order delivery for A2X). Additionally, or alternatively, a capability differentiator may be added to a corresponding per-UE V2X or sidelink capability indication (e.g., PDCP out-of-order delivery for A2X), where one or more capability differentiator bits may indicate whether the UE 115 or UAV 205 has associated functionality for A2X). Such capability bits or capability differentiator bits may apply to all per-UE level capabilities for V2X. For per-band capabilities, the capability bits or capability differentiator bits may be implicit based on one or more separate indications within each band (e.g., assuming V2X and A2X bands are not common).

In further aspects, as discussed above, one or more A2X-specific capability information messages 215 may be provided that are separate from V2X messages. In some examples, an A2X-specific message may indicate support of PC5-based BRID, such as through an indication of per-band support of BRID for one or more sidelink frequency bands, which may be conditional upon support of sidelink in that band. Additionally, or alternatively, such an A2X-specific capability information may indicate list of A2X specific sidelink band or sidelink band combinations where one or more A2X services is supported by the UE. Additionally, or alternatively, such an A2X-specific capability information may indicate per-UE capability to indicate support of PC5 based BRID as a separate capability, or provide implicit indication on support of BRID in at least one sidelink band. In some cases, such capability indications may also indicate support of BRID-specific PC5 quality indicator (PQI) reporting. In some cases, such an indication may be optional to support, because BRID may not be mandatory for UAVs in all regions.

In further examples, the one or more A2X-specific information messages 215 may indicate support of PC5-based DAA. For example, such an indication may indicate support of DAA in a sidelink band on a per-band basis (e.g., conditional upon support of sidelink in that band). In other examples, such a capability may be provided per UE as an optional capability to indicate support of PC5 based DAA. Such an indication may be provided as part of a defined separate capability indication, or may be implicit on support of DAA in at least one sidelink band. In some cases, such capability indications may also indicate support of DAA-specific PQI reporting. In some cases, such an indication may be optional to support, because DAA may not be mandatory for UAVs in all regions.

In further aspects, a single capability indicator of support of ‘A2X using PC5 broadcast may be provided. In some aspects, BRID and DAA may be considered different traffic within the single A2X service type, such a capability indicator may jointly indicate BRID capability for A2X receptions and DAA support for A2X transmissions. Similarly as with the separate DAA and BRID indications, such a joint capability indicator may be provided per-band, provided per-UE, defined as a separate capability, or implicit based on support of A2X in at least one sidelink band. In some cases, such a joint indication may be optional to support, because BRID and/or DAA may not be mandatory for UAVs in all regions.

In further aspects, one or more of the UE 115-a or the UAVs 205 may provide a capability information message 215 or an aerial UE related message to the network entity 105-a via an access link (e.g., a Uu link). In some cases, an aerial UE, such as UAVs 205, may provide one or more aerial-specific parameters to the network entity 105-a via an access link (e.g., the Uu link). For example, aerial-specific parameters such as multiple cell measurements (e.g., multipleCellsMeasExtension), height measurements (e.g., altitude measurements such as altitudeMeas), flight path information (e.g., flightPathReporting), or any combinations thereof may be provided by UAVs 205 via the access link (e.g., the UE 115-a or UAVs may report such parameters and/or measurements to the network entity 105-a via the access link). In some cases, a master capability bit (e.g., aerialUE-Capability) may indicate support of all or some of the aerial functions (which in some cases may also indicate support of handling aerial-specific out of band emission information, while in other cases the support of handling aerial-specific out of band emission information may be indicated separately e.g., multiNS-PmaxAerial and/or nr-NS-PmaxListAerial). In other examples, different capability indications may indicate one or more of support of altitude-dependent parameter for measurements (e.g., support of altitude dependent SSB measurement altitudeBasedSSB-ToMeasure, height dependent handover time-to-trigger (TTT), etc.), support of joint measurement-based and height-based (e.g., altitude-based) events that indicates support or no support of an event AxHy (x=3, 4, 5 and y=1, 2) (e.g. eventAxHy), support for one or more flight path capabilities, or support of UE assistance information indication of flight path availability (e.g., flightPathAvailabilityIndicationUAI). In some cases, the support for flight path capabilities may provide an indication of support for sending a flight path, support of flight path update trigger thresholds (e.g., an optional indication where, if not supported by a UAV 205, the network does not configure the thresholds to be used to determine whether UE may transmit updated flight path information), support of timestamps in the flight path (e.g., an optional indication that, if indicated as supported by a UAV 205, the UAV 205 may include a timestamp when available and, if indicated as ‘no support,’ the network should not expect timestamps and therefore could avoid requesting flight path updates).

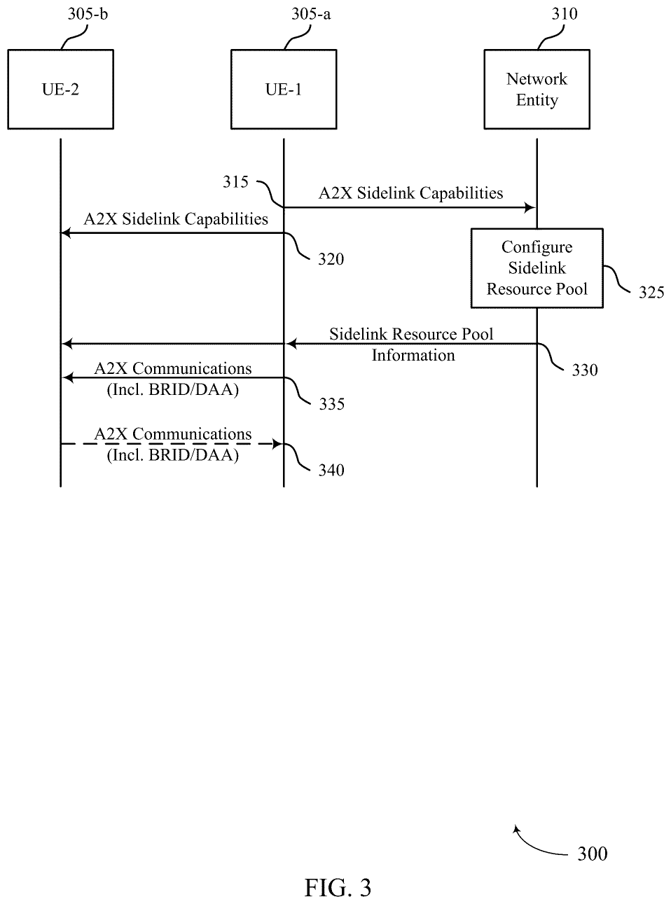

FIG. 3 shows an example of a process flow 300 that supports techniques for A2X communications in accordance with one or more aspects of the present disclosure. The process flow 300 may implement aspects of the wireless communications systems 100 and 200, or may be implemented by aspects of the wireless communications systems 100 and 200. For example, the process flow 300 may illustrate operations between a first UE 305-a and a second UE 305-b (e.g., UAVs or A2X devices) and a network entity 310, which may be examples of corresponding devices described herein. In the following description of the process flow 300, the operations between the UEs 305 and the network entity 310 may be transmitted in a different order than the example order shown, or the operations performed by the UEs 305 and the network entity 310 may be performed in different orders or at different times. Some operations may also be omitted from the process flow 300, and other operations may be added to the process flow 300.

At 315, the first UE 305-a may transmit, and the network entity 310 may receive, an indication of A2X sidelink capabilities of the first UE 305-a (e.g., via RRC signaling, downlink control information, a MAC control element, or any combinations thereof). In some cases, the A2X sidelink capabilities may indicate one or more of BRID message or DAA message capabilities. In some cases, at 320, the first UE 305-a may transmit, and the second UE 305-b may receive, the indication of A2X sidelink capabilities of the first UE 305-a (e.g., via sidelink control information (SCI), a MAC control element, or any combinations thereof). In some cases, the first UE 305-a may transmit a single indication of A2X sidelink capabilities that is received at both the network entity 310 and the second UE 305-b. In some cases, the second UE 305-b may be an aerial UE (e.g., a UAV), or a ground-based UE such as used by law enforcement or an entity responsible for managing UAV traffic for a particular area.

At 325, the network entity 310 may configure a sidelink resource pool. In some cases, the sidelink resource pool may be configured based on the indicated A2X capabilities received from one or more UEs 305. For example, the network entity 310 may configure sidelink resources for A2X communications that are sidelink mode 1 resources (e.g., resource allocations for sidelink are provided by the network), or may configure sidelink mode 2 resources that use random assignment of a subset of sidelink resources within the sidelink resource pool for transmission of sidelink messages (e.g., to accommodate one or more transmit-only UEs 305). In other examples, the sidelink resource pool may be configured for channel sensing prior to transmission using a subset of a sidelink resource pool, with such a configuration based on the UEs 305 indicating a capability for channel sensing prior to A2X transmissions.

At 330, the network entity 310 may transmit, and the UEs 305 may receive, sidelink resource pool information (e.g., via RRC signaling, downlink control information, a MAC control element, or any combinations thereof). In some cases, the sidelink resource pool information includes an indication of A2X resources, and may provide configuration information associated with the A2X resources (e.g., random selection or channel-sensing resource selection for mode 2 sidelink transmissions, and/or one or more sub-bands for A2X transmissions that may implicitly indicate one or more A2X parameters).

At 335, the first UE 305-a may transmit, and the second UE 305-b may receive, one or more A2X communications (e.g., via a physical sidelink shared channel (PSSCH), a physical sidelink control channel (PSCCH), a sidelink broadcast channel, or any combinations thereof). In some cases, the one or more A2X communications may include one or more of a BRID or a DAA communication. Optionally, at 340, the second UE 305-b may transmit, and the first UE 305-a may receive, the one or more A2X communications that may include one or more of a BRID or a DAA communication or another A2X communication.

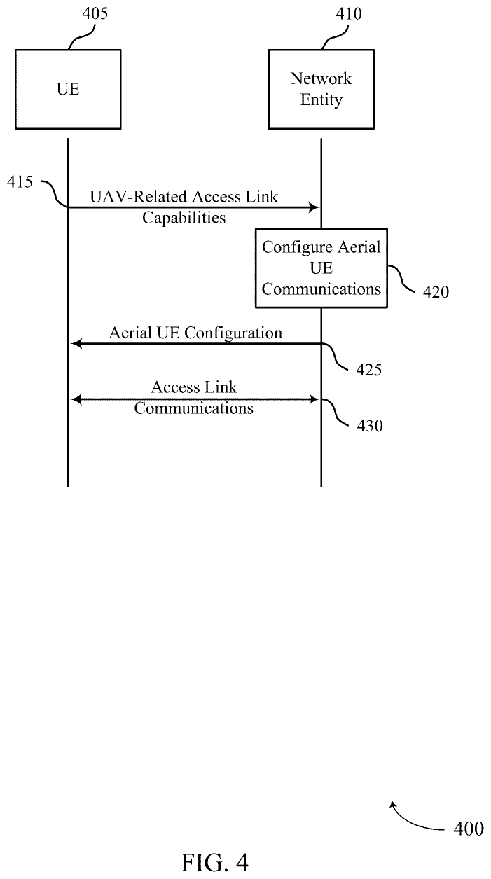

FIG. 4 shows an example of a process flow 400 that supports techniques for A2X communications in accordance with one or more aspects of the present disclosure. The process flow 400 may implement aspects of the wireless communications systems 100 and 200, or may be implemented by aspects of the wireless communications systems 100 and 200. For example, the process flow 400 may illustrate operations between a UE 405 (e.g., a UAV or A2X device) and a network entity 410, which may be examples of corresponding devices described herein. In the following description of the process flow 400, the operations between the UE 405 and the network entity 410 may be transmitted in a different order than the example order shown, or the operations performed by the UE 405 and the network entity 410 may be performed in different orders or at different times. Some operations may also be omitted from the process flow 400, and other operations may be added to the process flow 400.

At 415, the UE 405 may transmit, and the network entity 410 may receive, an indication of UAV-related access link capabilities of the UE 405 (e.g., via RRC signaling, uplink control information, a MAC control element, or any combinations thereof). In some cases, the UAV-related access link capabilities may indicate one or more of a master capability bit to indicate support of all aerial functions, support of a height-dependent (e.g., altitude-dependent) parameter for measurements (e.g., support of height dependent SSB measurement, height dependent TTT, etc.), support of joint Ax+Hx event (e.g., support/no support of A3+H2 event), additional flight path capabilities (e.g., delta flight path that provides an optional capability to indicate the UE 405 supports sending flight path; support of flight path update trigger thresholds that provides an optional indication that, if not supported by the UE 405, the network entity 410 does not configure the thresholds; support of timestamp in the flight path that provides an optional indication where, if indicated as supported by the UE 405, the UE 405 may include timestamp when available and, if ‘no support’, the network entity 410 should not expect timestamps and therefore may avoid requesting flight path updates), support of UE assistance information (UAI) with an indication of flight path availability.

At 420, the network entity 410 may configure communications for the aerial UE based at least in part on the UAV-related access link capabilities. In some cases, the communications may be configured to provide one or more of a height-dependent (e.g., altitude-dependent) parameter for measurements, an AxHy event (e.g., an A3H2 event), one or more thresholds to trigger a flight path update, one or more other aerial UE functions, or any combinations thereof. For example, an AxHy event may be defined as combination of events A3, A4 or A5, with H1, or H2 events. In such case the entering and exiting condition of the combined event AxHy may include combined conditions corresponding to events Ax and Hy. At 425, the network entity 410 may transmit, and the UE 405 may receive, the aerial UE configuration (e.g., via RRC signaling, downlink control information, a MAC control element, or any combinations thereof). At 430, the UE 405 and the network entity 410 may exchange access link communications. As discussed herein, in some cases, the access link communications may include aerial UE-related information, such as height-based (e.g., altitude-based) measurement reports, one or more flight path updates, UAI with height-dependent (e.g., altitude-dependent) parameter measurements or flight path updates, and the like.

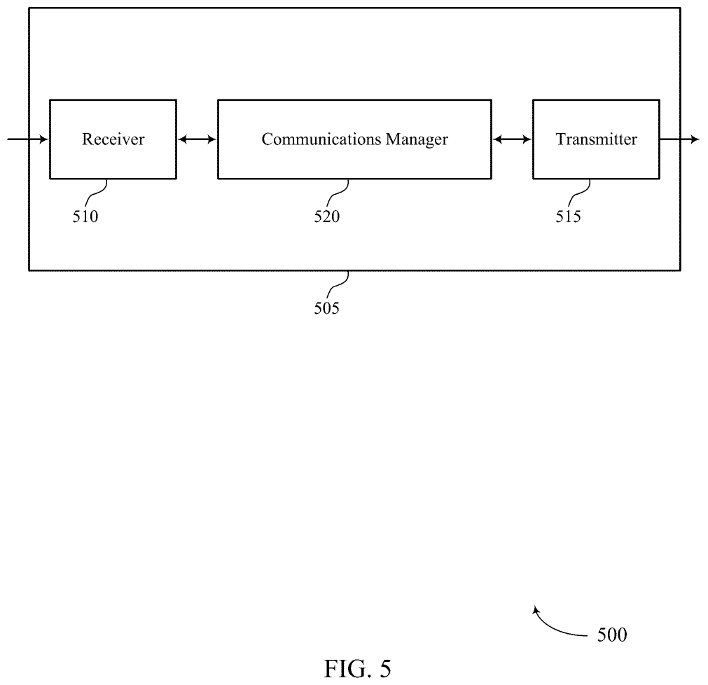

FIG. 5 shows a block diagram 500 of a device 505 that supports techniques for A2X communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to A2X communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to A2X communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of A2X communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for transmitting a capability indication of the UE, where the capability indication indicates one or more supported functions that use A2X communication via a sidelink connection of the UE. The communications manager 520 is capable of, configured to, or operable to support a means for transmitting or receiving one or more A2X transmissions using at least a subset of a resource allocation that is determined from a set of sidelink resources for A2X communications.

Additionally, or alternatively, the communications manager 520 may support wireless communication in accordance with examples as disclosed herein. For example, the communications manager 520 is capable of, configured to, or operable to support a means for receiving a capability indication from an aerial UE, where the capability indication indicates one or more supported functions that use A2X communication of the aerial UE. The communications manager 520 is capable of, configured to, or operable to support a means for transmitting or receiving one or more A2X transmissions using at least a subset of a resource allocation of sidelink resources for A2X communications.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for A2X communications based on A2X capability indications, which may provide for reduced signaling overhead, reduced power consumption, more efficient utilization of communication resources, and flexibility for reduced complexity and reduced cost UAV communications components.

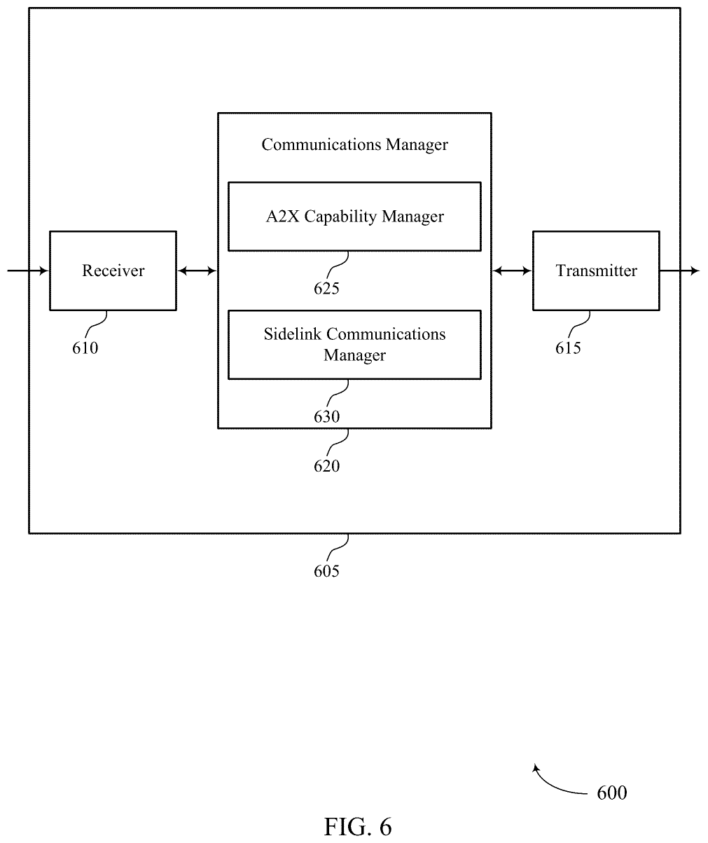

FIG. 6 shows a block diagram 600 of a device 605 that supports techniques for A2X communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to A2X communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to A2X communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of A2X communications as described herein. For example, the communications manager 620 may include an A2X capability manager 625 a sidelink communications manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The A2X capability manager 625 is capable of, configured to, or operable to support a means for transmitting a capability indication of the UE, where the capability indication indicates one or more supported functions that use A2X communication via a sidelink connection of the UE. The sidelink communications manager 630 is capable of, configured to, or operable to support a means for transmitting or receiving one or more A2X transmissions using at least a subset of a resource allocation that is determined from a set of sidelink resources for A2X communications.

Additionally, or alternatively, the communications manager 620 may support wireless communication in accordance with examples as disclosed herein. The A2X capability manager 625 is capable of, configured to, or operable to support a means for receiving a capability indication from an aerial UE, where the capability indication indicates one or more supported functions that use A2X communication of the aerial UE. The sidelink communications manager 630 is capable of, configured to, or operable to support a means for transmitting or receiving one or more A2X transmissions using at least a subset of a resource allocation of sidelink resources for A2X communications.

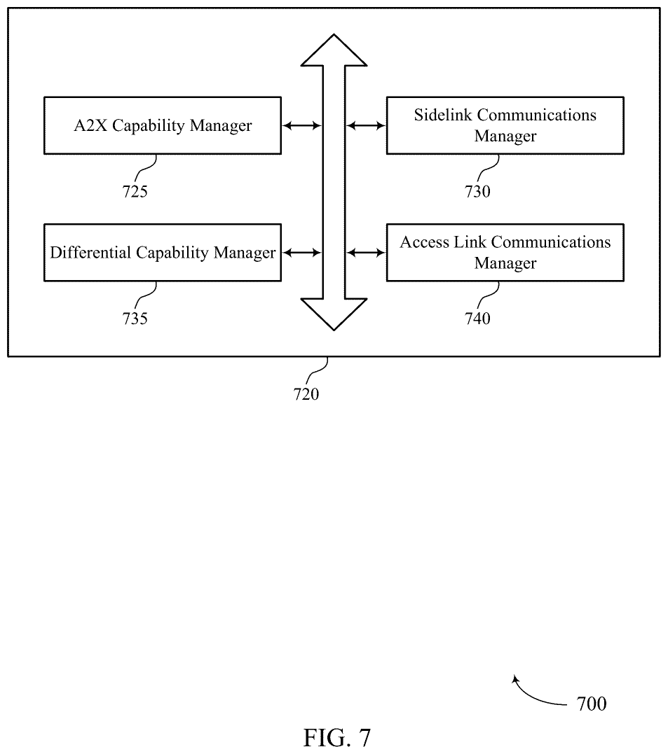

FIG. 7 shows a block diagram 700 of a communications manager 720 that supports techniques for A2X communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of A2X communications as described herein. For example, the communications manager 720 may include an A2X capability manager 725, a sidelink communications manager 730, a differential capability manager 735, an access link communications manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The A2X capability manager 725 is capable of, configured to, or operable to support a means for transmitting a capability indication of the UE, where the capability indication indicates one or more supported functions that use A2X communication via a sidelink connection of the UE. The sidelink communications manager 730 is capable of, configured to, or operable to support a means for transmitting or receiving one or more of A2X transmissions using at least a subset of a resource allocation that is determined from a set of sidelink resources for A2X communications.

In some examples, to support transmitting the capability indication, the A2X capability manager 725 is capable of, configured to, or operable to support a means for transmitting a set of supported A2X parameters that are separate from a different set of V2X communication parameters for sidelink communications. In some examples, the A2X capability manager 725 is capable of, configured to, or operable to support a means for transmitting a capability indication for sidelink communications, where the A2X communication is dependent on support of sidelink communications at the UE.

In some examples, to support transmitting the capability indication, the A2X capability manager 725 is capable of, configured to, or operable to support a means for transmitting one or more A2X capability parameters that indicate support for one or more of BRID communications or DAA communications, where the one or more A2X capability parameters are independent of V2X communications parameters. In some examples, to support transmitting the capability indication, the A2X capability manager 725 is capable of, configured to, or operable to support a means for transmitting a capability indication for a subset of V2X communications, that indicates the UE supports less than all V2X communication capabilities. In some examples, the capability indication indicates the UE supports receive-only functions of A2X communications. In some examples, the capability indication indicates the UE supports transmit-only functions of A2X communications. In some examples, the capability indication indicates the UE supports channel sensing for a sidelink channel, and supports transmit-only functions of A2X communications. In some examples, the capability indication is provided in one or more A2X capability bits that are appended to one or more sidelink (e.g., V2X) capability messages.

In some examples, to support transmitting the capability indication, the differential capability manager 735 is capable of, configured to, or operable to support a means for transmitting the capability indication as a differential capability from an associated V2X communication capability. In some examples, the capability indication includes separate indications of support for BRID communications and DAA communications. In some examples, the separate indications are independent of V2X communications parameters. In some examples, the capability indication includes a single indication of support for BRID communications and/or DAA communications. In some examples, the single indication is independent of V2X communications parameters. In some examples, the single indication may be a two-bit field that indicates support for BRID communications, DAA communications, both (or neither). For example, the absence of the field may indicate support for neither, a value of “00” may indicate support for BRID communications and not DAA communications, a value of “01” may indicate support for DAA communications and not BRID communications, and a value of “10” may indicate support for both BRID communications and DAA communications. A value of “11” may be reserved for future use.

In some examples, the access link communications manager 740 is capable of, configured to, or operable to support a means for transmitting an indication to a network entity of one or more supported UE functions that use an access link with the network entity. In some examples, the one or more supported UE functions include one or more of height-dependent (e.g., altitude-dependent) parameter reporting, joint measurement and height-dependent (e.g., altitude-dependent) parameter reporting, flight path parameter reporting, or any combinations thereof.

In some examples, the one or more A2X transmissions include one or more of a BRID or a DAA transmission.

In some examples, the capability indication indicates a list of one or more A2X sidelink bands or sidelink band combinations where one or more A2X services are supported by the UE.

Additionally, or alternatively, the communications manager 720 may support wireless communication in accordance with examples as disclosed herein. In some examples, the A2X capability manager 725 is capable of, configured to, or operable to support a means for receiving a capability indication from an aerial UE, where the capability indication indicates one or more supported functions that use A2X communication of the aerial UE. In some examples, the sidelink communications manager 730 is capable of, configured to, or operable to support a means for transmitting or receiving one or more A2X transmissions using at least a subset of a resource allocation of sidelink resources for A2X communications.

In some examples, the capability indication indicates a set of supported A2X parameters that are separate from a different set of V2X communication parameters for sidelink communications, that are independent of V2X communications parameters, that are dependent on one or more V2X communications parameters, that indicates the aerial UE supports less than all V2X communication capabilities, that indicates the aerial UE supports receive-only functions of A2X communications, that indicates the aerial UE supports transmit-only functions of A2X communications, or that indicates the aerial UE supports only channel sensing receptions for a sidelink channel.

In some examples, the capability indication is provided in one or more A2X capability bits that are appended to one or more sidelink (e.g., V2X) capability messages. In some examples, the capability indication is a differential capability from an associated V2X communication capability. In some examples, the capability indication includes separate indications of support for BRID communications and DAA communications In some examples, the separate indications are independent of V2X communications parameters. In some examples, the capability indication includes a single indication of support for BRID communications and DAA communications. In some examples, the single indication is independent of V2X communications parameters. In some examples, the single indication may be a two-bit field that indicates support for BRID communications, DAA communications, or both (or neither).

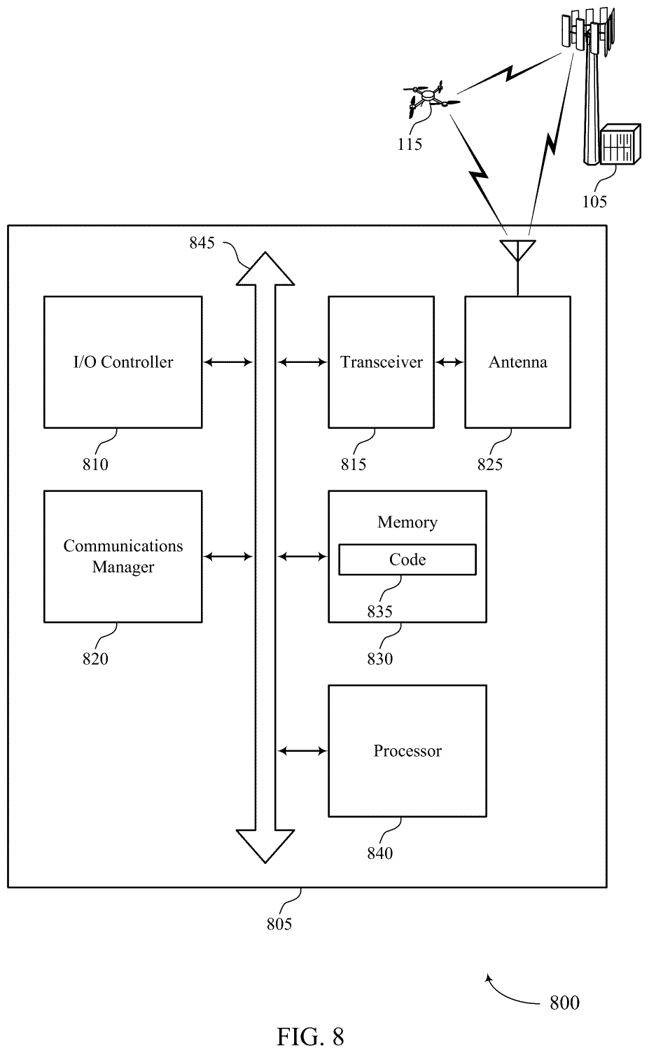

FIG. 8 shows a diagram of a system 800 including a device 805 that supports techniques for A2X communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting A2X communications). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for transmitting a capability indication of the UE, where the capability indication indicates one or more supported functions that use A2X communication via a sidelink connection of the UE. The communications manager 820 is capable of, configured to, or operable to support a means for transmitting or receiving one or more A2X transmissions using at least a subset of a resource allocation that is determined from a set of sidelink resources for A2X communications.

Additionally, or alternatively, the communications manager 820 may support wireless communication in accordance with examples as disclosed herein. For example, the communications manager 820 is capable of, configured to, or operable to support a means for receiving a capability indication from an aerial UE, where the capability indication indicates one or more supported functions that use A2X communication of the aerial UE. The communications manager 820 is capable of, configured to, or operable to support a means for transmitting or receiving one or more A2X transmissions using at least a subset of a resource allocation of sidelink resources for A2X communications.

By including or configuring the communications manager 820 in accordance with examples as described herein, the device 805 may support techniques for A2X communications based on A2X capability indications, which may provide for reduced signaling overhead, reduced power consumption, more efficient utilization of communication resources, and flexibility for reduced complexity and reduced cost UAV communications components.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of A2X communications as described herein, or the at least one processor 840 and the at least one memory 830 may be otherwise configured to, individually or collectively, perform or support such operations.

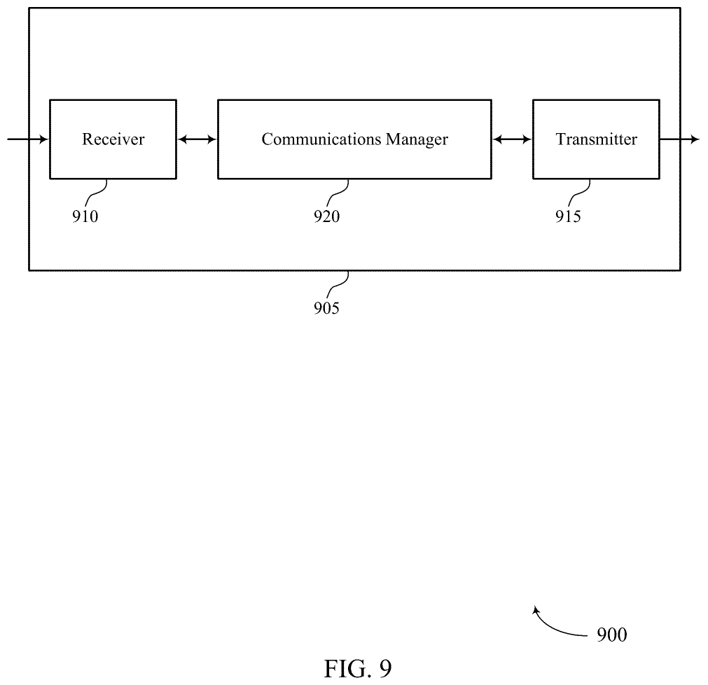

FIG. 9 shows a block diagram 900 of a device 905 that supports techniques for A2X communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of A2X communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for receiving a capability indication from an aerial UE, where the capability indication indicates one or more supported functions that use A2X communication of the aerial UE. The communications manager 920 is capable of, configured to, or operable to support a means for transmitting, to the aerial UE and one or more other UEs, a resource allocation for a set of sidelink resources for A2X communications.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for A2X communications based on A2X capability indications, which may provide for reduced signaling overhead, reduced power consumption, more efficient utilization of communication resources, and flexibility for reduced complexity and reduced cost UAV communications components.

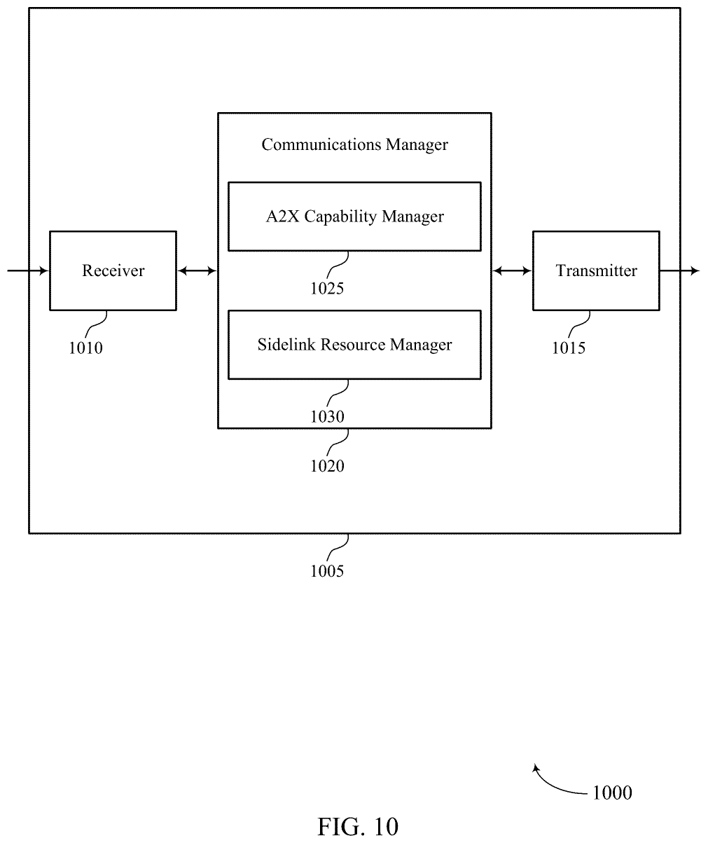

FIG. 10 shows a block diagram 1000 of a device 1005 that supports techniques for A2X communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of A2X communications as described herein. For example, the communications manager 1020 may include an A2X capability manager 1025 a sidelink resource manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The A2X capability manager 1025 is capable of, configured to, or operable to support a means for receiving a capability indication from an aerial UE, where the capability indication indicates one or more supported functions that use A2X communication of the aerial UE. The sidelink resource manager 1030 is capable of, configured to, or operable to support a means for transmitting, to the aerial UE and one or more other UEs, a resource allocation for a set of sidelink resources for A2X communications.

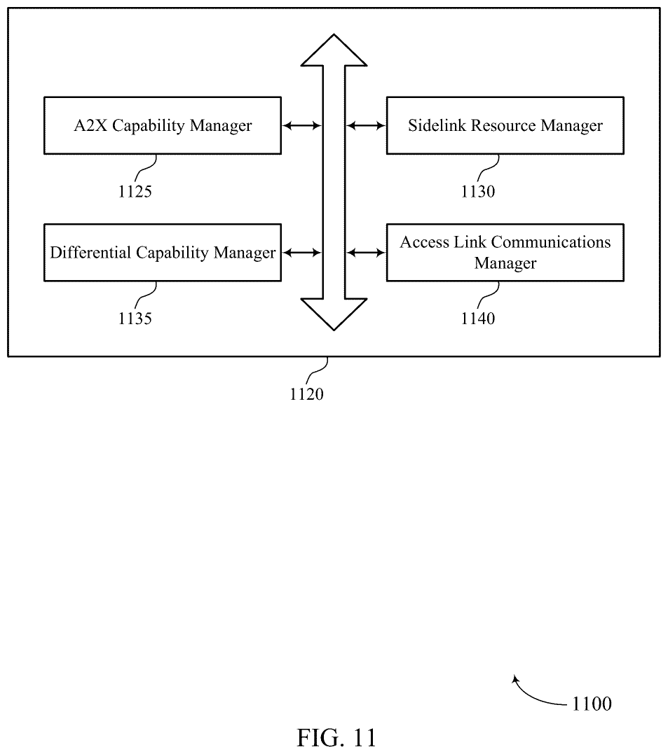

FIG. 11 shows a block diagram 1100 of a communications manager 1120 that supports techniques for A2X communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of A2X communications as described herein. For example, the communications manager 1120 may include an A2X capability manager 1125, a sidelink resource manager 1130, a differential capability manager 1135, an access link communications manager 1140, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The A2X capability manager 1125 is capable of, configured to, or operable to support a means for receiving a capability indication from an aerial UE, where the capability indication indicates one or more supported functions that use A2X communication of the aerial UE. The sidelink resource manager 1130 is capable of, configured to, or operable to support a means for transmitting, to the aerial UE and one or more other UEs, a resource allocation for a set of sidelink resources for A2X communications.

In some examples, to support receiving the capability indication, the A2X capability manager 1125 is capable of, configured to, or operable to support a means for receiving, from the aerial UE, a set of supported A2X parameters that are separate from a different set of V2X communication parameters for sidelink communications. In some examples, the A2X capability manager 1125 is capable of, configured to, or operable to support a means for receiving, from the aerial UE, a capability indication for sidelink communications, where the A2X communication is dependent on support of sidelink communications at the aerial UE. In some examples, to support receiving the capability indication, the A2X capability manager 1125 is capable of, configured to, or operable to support a means for receiving, from the aerial UE, one or more A2X capability parameters that indicate support for one or more of BRID communications or DAA communications, where the one or more A2X capability parameters are independent of V2X communications parameters.

In some examples, to support receiving the capability indication, the A2X capability manager 1125 is capable of, configured to, or operable to support a means for receiving, from the aerial UE, a capability indication for a subset of V2X communications, that indicates the aerial UE supports less than all V2X communication capabilities. In some examples, the capability indication indicates the aerial UE supports receive-only functions of A2X communications. In some examples, the capability indication indicates the aerial UE supports transmit-only functions of A2X communications. In some examples, the capability indication indicates the aerial UE supports channel sensing for a sidelink channel, and supports transmit-only functions of A2X communications. In some examples, the capability indication is provided in one or more A2X capability bits that are appended to one or more sidelink (e.g., V2X) capability messages.

In some examples, to support receiving the capability indication, the differential capability manager 1135 is capable of, configured to, or operable to support a means for receiving, from the aerial UE, the capability indication as a differential capability from an associated V2X communication capability. In some examples, the capability indication includes separate indications of support for BRID communications and DAA communications. In some examples, the separate indications are independent of V2X communications parameters. In some examples, the capability indication includes a single indication of support for BRID communications and DAA communications. In some examples, the single indication is independent of V2X communications parameters. In some examples, the single indication may be a two-bit field that indicates support for BRID communications, DAA communications, or both (or neither).

In some examples, the access link communications manager 1140 is capable of, configured to, or operable to support a means for receiving, from the aerial UE, an indication of one or more supported aerial UE functions that use an access link with the network entity. In some examples, the one or more aerial UE functions include one or more of height-dependent parameter reporting, joint measurement and height-dependent parameter reporting, flight path parameter reporting, or any combinations thereof.

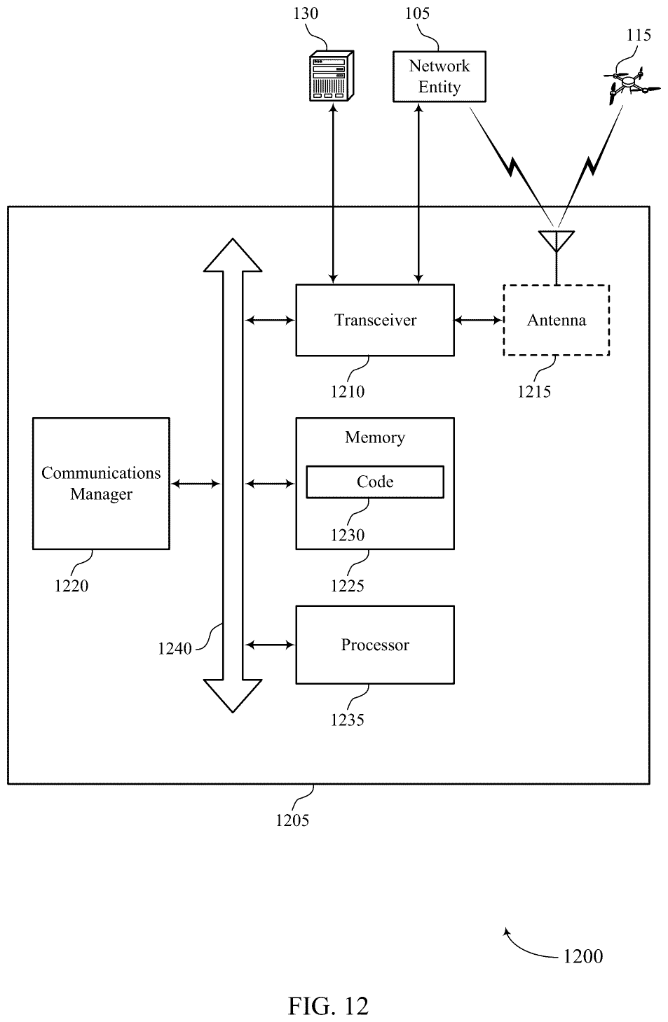

FIG. 12 shows a diagram of a system 1200 including a device 1205 that supports techniques for A2X communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting A2X communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for receiving a capability indication from an aerial UE, where the capability indication indicates one or more supported functions that use A2X communication of the aerial UE. The communications manager 1220 is capable of, configured to, or operable to support a means for transmitting, to the aerial UE and one or more other UEs, a resource allocation for a set of sidelink resources for A2X communications.

By including or configuring the communications manager 1220 in accordance with examples as described herein, the device 1205 may support techniques for A2X communications based on A2X capability indications, which may provide for reduced signaling overhead, reduced power consumption, more efficient utilization of communication resources, and flexibility for reduced complexity and reduced cost UAV communications components.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of A2X communications as described herein, or the at least one processor 1235 and the at least one memory 1225 may be otherwise configured to, individually or collectively, perform or support such operations.

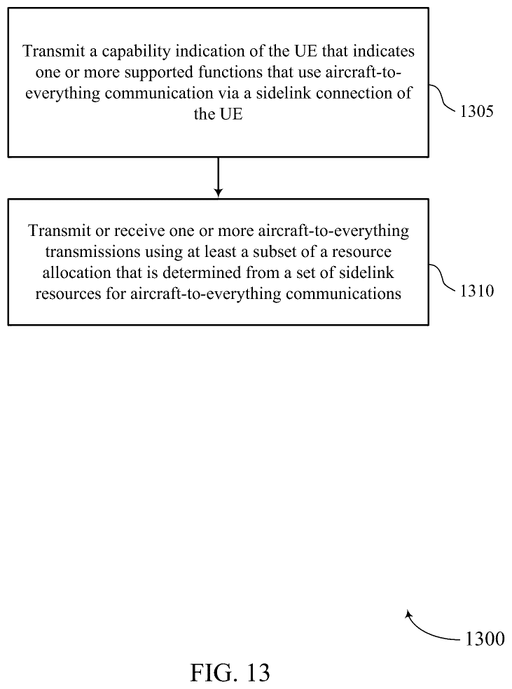

FIG. 13 shows a flowchart illustrating a method 1300 that supports techniques for A2X communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a capability indication of the aerial UE, where the capability indication indicates one or more supported functions that use A2X communication via a sidelink connection of the aerial UE. The operations of block 1305 may be performed in accordance with examples as disclosed herein. In some examples, aspects of the operations of 1305 may be performed by an A2X capability manager 725 as described with reference to FIG. 7.

At 1310, the method may include transmitting or receiving one or more A2X transmissions using at least a subset of a resource allocation that is determined from a set of sidelink resources for A2X communications. The operations of block 1310 may be performed in accordance with examples as disclosed herein. In some examples, aspects of the operations of 1310 may be performed by a sidelink communications manager 730 as described with reference to FIG. 7.

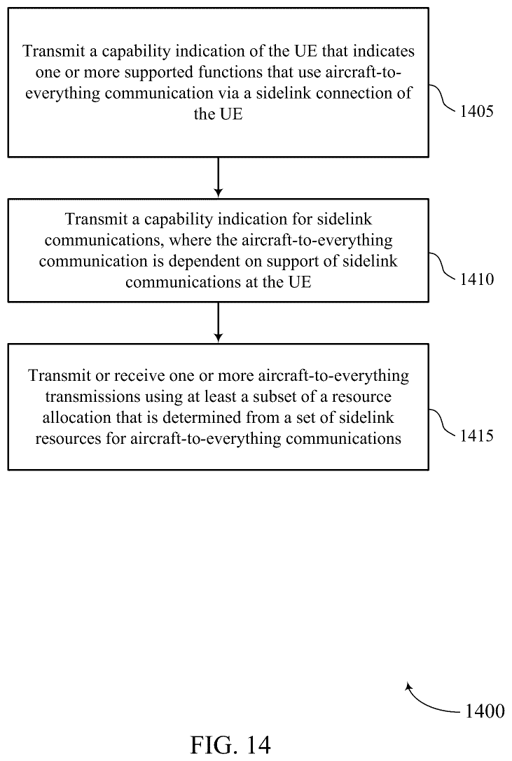

FIG. 14 shows a flowchart illustrating a method 1400 that supports techniques for A2X communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability indication of the UE that indicates one or more supported functions that use A2X communication via a sidelink connection of the UE. The operations of block 1405 may be performed in accordance with examples as disclosed herein. In some examples, aspects of the operations of 1405 may be performed by an A2X capability manager 725 as described with reference to FIG. 7.

At 1410, the method may include transmitting a capability indication for sidelink communications, where the A2X communication is dependent on support of sidelink communications at the UE. The operations of block 1410 may be performed in accordance with examples as disclosed herein. In some examples, aspects of the operations of 1410 may be performed by an A2X capability manager 725 as described with reference to FIG. 7.

At 1415, the method may include transmitting or receiving one or more of A2X transmissions using at least a subset of a resource allocation that is determined from a set of sidelink resources for A2X communications. The operations of block 1415 may be performed in accordance with examples as disclosed herein. In some examples, aspects of the operations of 1415 may be performed by a sidelink communications manager 730 as described with reference to FIG. 7.

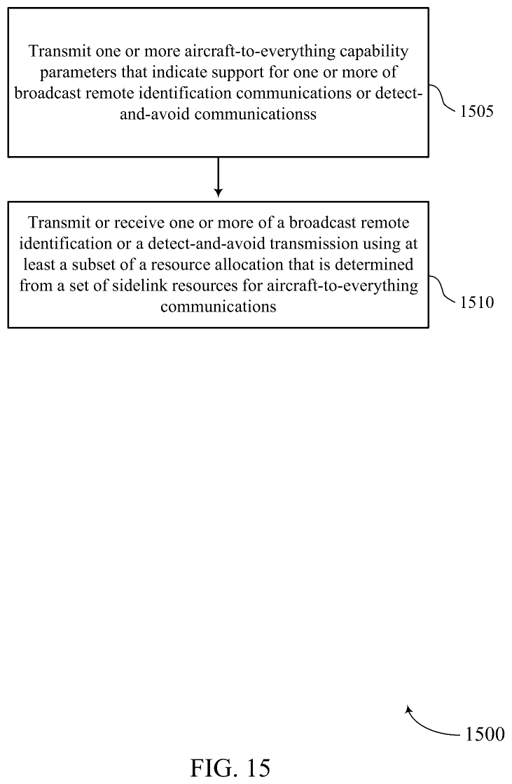

FIG. 15 shows a flowchart illustrating a method 1500 that supports techniques for A2X communications in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting one or more A2X capability parameters that indicate support for one or more of BRID communications or DAA communications. In some examples, the one or more A2X capability parameters are independent of V2X communications parameters. The operations of block 1505 may be performed in accordance with examples as disclosed herein. In some examples, aspects of the operations of 1505 may be performed by an A2X capability manager 725 as described with reference to FIG. 7.

At 1510, the method may include transmitting or receiving one or more of a BRID or a DAA transmission using at least a subset of a resource allocation that is determined from a set of sidelink resources for A2X communications. The operations of block 1510 may be performed in accordance with examples as disclosed herein. In some examples, aspects of the operations of 1510 may be performed by a sidelink communications manager 730 as described with reference to FIG. 7.

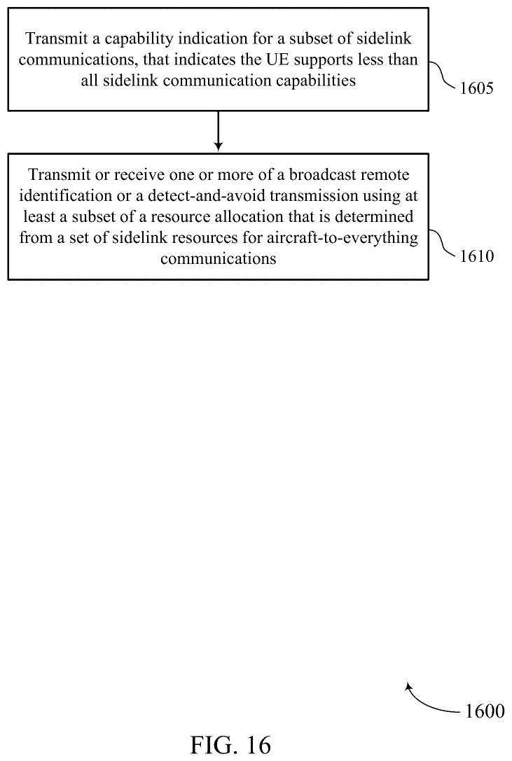

FIG. 16 shows a flowchart illustrating a method 1600 that supports techniques for A2X communications in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include transmitting a capability indication for a subset of sidelink communications, that indicates the UE supports less than all sidelink communication capabilities. The operations of block 1605 may be performed in accordance with examples as disclosed herein. In some examples, aspects of the operations of 1605 may be performed by an A2X capability manager 725 as described with reference to FIG. 7.

At 1610, the method may include transmitting or receiving one or more of a BRID or a DAA transmission using at least a subset of a resource allocation that is determined from a set of sidelink resources for A2X communications. The operations of block 1610 may be performed in accordance with examples as disclosed herein. In some examples, aspects of the operations of 1610 may be performed by a sidelink communications manager 730 as described with reference to FIG. 7.

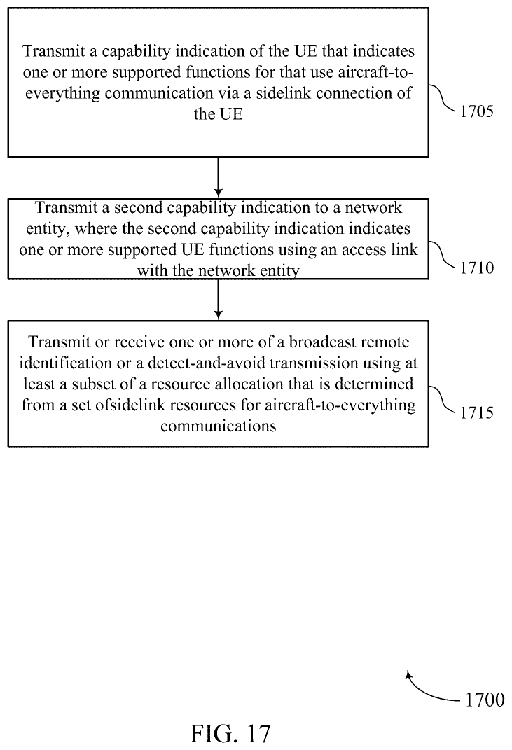

FIG. 17 shows a flowchart illustrating a method 1700 that supports techniques for A2X communications in accordance with aspects of the present disclosure. The operations of the method 1700 may be implemented by a UE or its components as described herein. For example, the operations of the method 1700 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1705, the method may include transmitting a capability indication of the UE, where the capability indication indicates one or more supported functions that use A2X communication via a sidelink connection of the UE. The operations of block 1705 may be performed in accordance with examples as disclosed herein. In some examples, aspects of the operations of 1705 may be performed by an A2X capability manager 725 as described with reference to FIG. 7.

At 1710, the method may include transmitting an indication to a network entity of one or more supported UE functions using an access link with the network entity. The operations of block 1710 may be performed in accordance with examples as disclosed herein. In some examples, aspects of the operations of 1710 may be performed by an access link communications manager 740 as described with reference to FIG. 7.

At 1715, the method may include transmitting or receiving one or more A2X transmissions at least a subset of a resource allocation that is determined from a set of sidelink resources for A2X communications. The operations of block 1715 may be performed in accordance with examples as disclosed herein. In some examples, aspects of the operations of 1715 may be performed by a sidelink communications manager 730 as described with reference to FIG. 7.

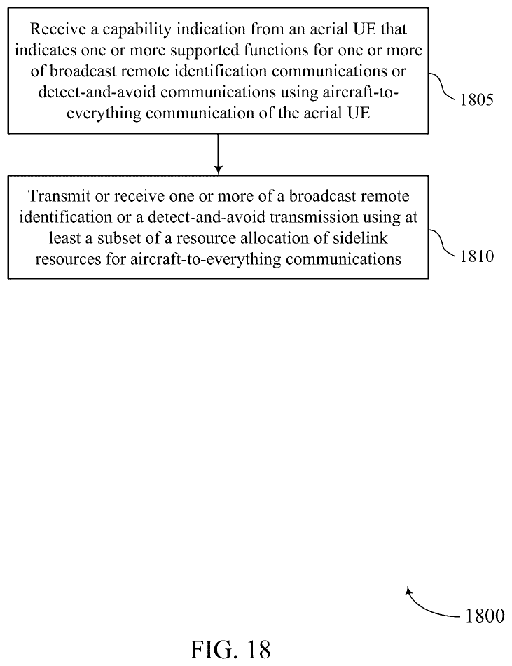

FIG. 18 shows a flowchart illustrating a method 1800 that supports techniques for A2X communications in accordance with aspects of the present disclosure. The operations of the method 1800 may be implemented by a UE or its components as described herein. For example, the operations of the method 1800 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1805, the method may include receiving a capability indication from an aerial UE, where the capability indication indicates one or more supported functions for one or more of BRID communications or DAA communications using A2X communication of the aerial UE. The operations of block 1805 may be performed in accordance with examples as disclosed herein. In some examples, aspects of the operations of 1805 may be performed by an A2X capability manager 725 as described with reference to FIG. 7.

At 1810, the method may include transmitting or receiving one or more of a BRID or a DAA transmission using at least a subset of a resource allocation of sidelink resources for A2X communications. The operations of block 1810 may be performed in accordance with examples as disclosed herein. In some examples, aspects of the operations of 1810 may be performed by a sidelink communications manager 730 as described with reference to FIG. 7.

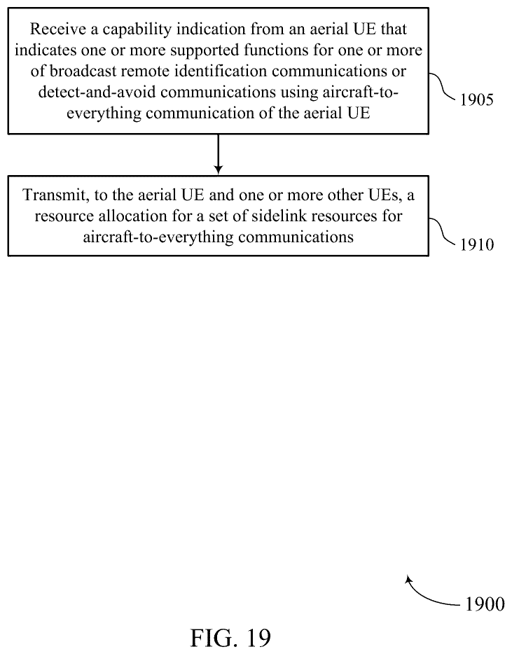

FIG. 19 shows a flowchart illustrating a method 1900 that supports techniques for A2X communications in accordance with aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include receiving a capability indication from an aerial UE, where the capability indication indicates one or more supported functions for one or more of BRID communications or DAA communications using A2X communication of the aerial UE. The operations of block 1905 may be performed in accordance with examples as disclosed herein. In some examples, aspects of the operations of 1905 may be performed by an A2X capability manager 1125 as described with reference to FIG. 11.

At 1910, the method may include transmitting, to the aerial UE and one or more other UEs, a resource allocation for a set of sidelink resources for A2X communications. The operations of block 1910 may be performed in accordance with examples as disclosed herein. In some examples, aspects of the operations of 1910 may be performed by a sidelink resource manager 1130 as described with reference to FIG. 11.

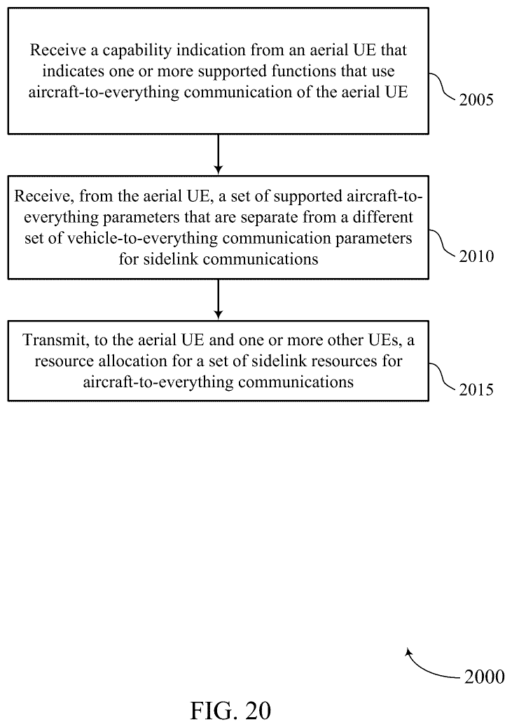

FIG. 20 shows a flowchart illustrating a method 2000 that supports techniques for A2X communications in accordance with aspects of the present disclosure. The operations of the method 2000 may be implemented by a network entity or its components as described herein. For example, the operations of the method 2000 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2005, the method may include receiving a capability indication from an aerial UE, where the capability indication indicates one or more supported functions that use A2X communication of the aerial UE. The operations of block 2005 may be performed in accordance with examples as disclosed herein. In some examples, aspects of the operations of 2005 may be performed by an A2X capability manager 1125 as described with reference to FIG. 11.

At 2010, the method may include receiving, from the aerial UE, a set of supported A2X parameters that are separate from a different set of V2X communication parameters for sidelink communications. The operations of block 2010 may be performed in accordance with examples as disclosed herein. In some examples, aspects of the operations of 2010 may be performed by an A2X capability manager 1125 as described with reference to FIG. 11.

At 2015, the method may include transmitting, to the aerial UE and one or more other UEs, a resource allocation for a set of sidelink resources for A2X communications. The operations of block 2015 may be performed in accordance with examples as disclosed herein. In some examples, aspects of the operations of 2015 may be performed by a sidelink resource manager 1130 as described with reference to FIG. 11.

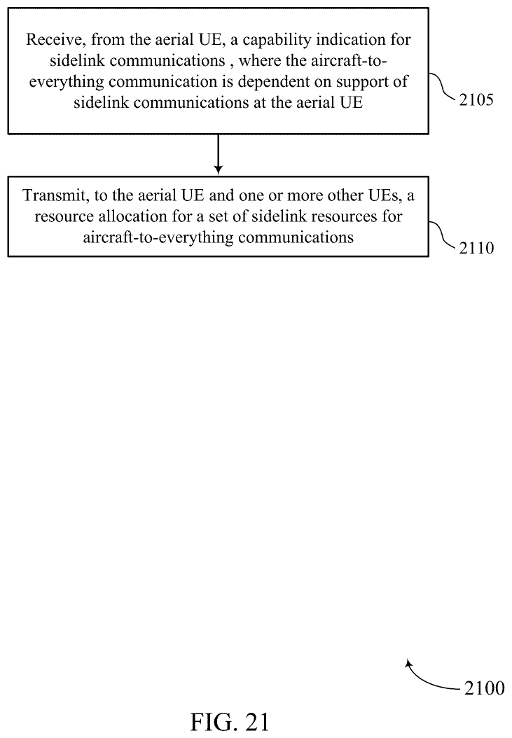

FIG. 21 shows a flowchart illustrating a method 2100 that supports techniques for A2X communications in accordance with aspects of the present disclosure. The operations of the method 2100 may be implemented by a network entity or its components as described herein. For example, the operations of the method 2100 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2105, the method may include receiving, from the aerial UE, a capability indication for sidelink communications, where the A2X communication is dependent on support of sidelink communications at the aerial UE. The operations of block 2105 may be performed in accordance with examples as disclosed herein. In some examples, aspects of the operations of 2105 may be performed by an A2X capability manager 1125 as described with reference to FIG. 11.

At 2110, the method may include transmitting, to the aerial UE and one or more other UEs, a resource allocation for a set of sidelink resources for A2X communications. The operations of block 2110 may be performed in accordance with examples as disclosed herein. In some examples, aspects of the operations of 2110 may be performed by a sidelink resource manager 1130 as described with reference to FIG. 11.

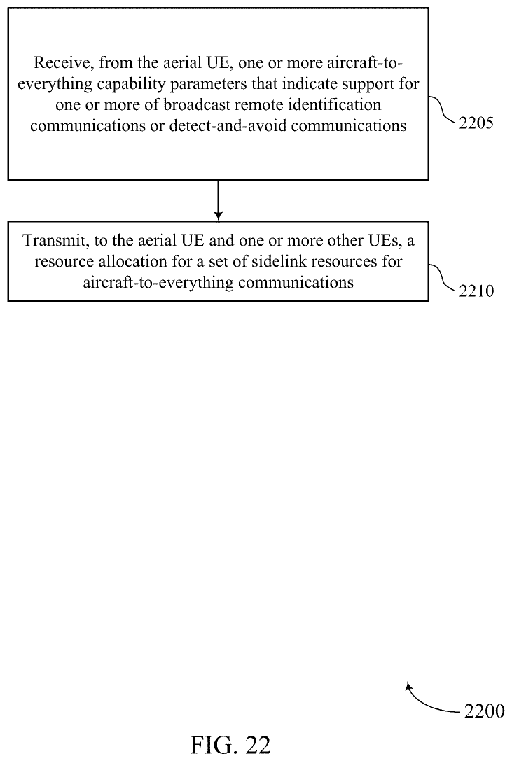

FIG. 22 shows a flowchart illustrating a method 2200 that supports techniques for A2X communications in accordance with aspects of the present disclosure. The operations of the method 2200 may be implemented by a network entity or its components as described herein. For example, the operations of the method 2200 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2205, the method may include receiving, from the aerial UE, one or more A2X capability parameters that indicate support for one or more of BRID communications or DAA communications. In some examples, the one or more A2X capability parameters are independent of V2X communications parameters. The operations of block 2205 may be performed in accordance with examples as disclosed herein. In some examples, aspects of the operations of 2205 may be performed by an A2X capability manager 1125 as described with reference to FIG. 11.

At 2210, the method may include transmitting, to the aerial UE and one or more other UEs, a resource allocation for a set of sidelink resources for A2X communications. The operations of block 2210 may be performed in accordance with examples as disclosed herein. In some examples, aspects of the operations of 2210 may be performed by a sidelink resource manager 1130 as described with reference to FIG. 11.

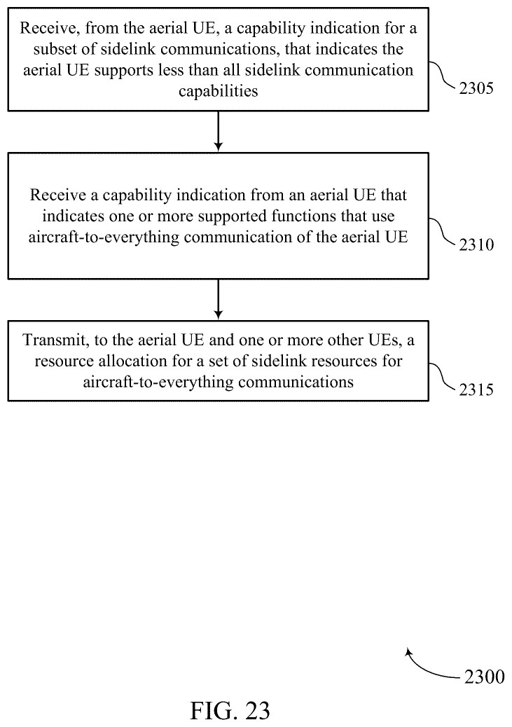

FIG. 23 shows a flowchart illustrating a method 2300 that supports techniques for A2X communications in accordance with aspects of the present disclosure. The operations of the method 2300 may be implemented by a network entity or its components as described herein. For example, the operations of the method 2300 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2305, the method may include receiving, from the aerial UE, a capability indication for a subset of sidelink communications, that indicates the aerial UE supports less than all sidelink communication capabilities. The operations of block 2305 may be performed in accordance with examples as disclosed herein. In some examples, aspects of the operations of 2305 may be performed by an A2X capability manager 1125 as described with reference to FIG. 11.

At 2310, the method may include receiving a capability indication from an aerial UE, where the capability indication indicates one or more supported functions that use A2X communication of the aerial UE. The operations of block 2310 may be performed in accordance with examples as disclosed herein. In some examples, aspects of the operations of 2310 may be performed by an A2X capability manager 1125 as described with reference to FIG. 11.

At 2315, the method may include transmitting, to the aerial UE and one or more other UEs, a resource allocation for a set of sidelink resources for A2X communications. The operations of block 2315 may be performed in accordance with examples as disclosed herein. In some examples, aspects of the operations of 2315 may be performed by a sidelink resource manager 1130 as described with reference to FIG. 11.

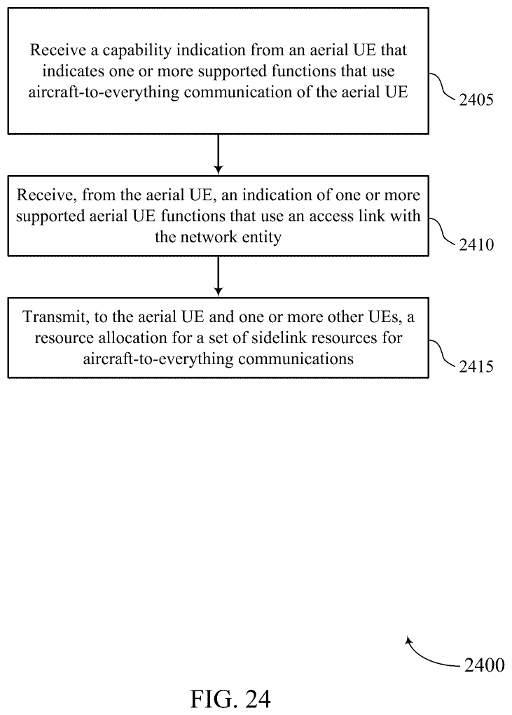

FIG. 24 shows a flowchart illustrating a method 2400 that supports techniques for A2X communications in accordance with aspects of the present disclosure. The operations of the method 2400 may be implemented by a network entity or its components as described herein. For example, the operations of the method 2400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2405, the method may include receiving a capability indication from an aerial UE, where the capability indication indicates one or more supported functions that use A2X communication of the aerial UE. The operations of block 2405 may be performed in accordance with examples as disclosed herein. In some examples, aspects of the operations of 2405 may be performed by an A2X capability manager 1125 as described with reference to FIG. 11.

At 2410, the method may include receiving, from the aerial UE, an indication of one or more supported aerial UE functions that use an access link with the network entity. The operations of block 2410 may be performed in accordance with examples as disclosed herein. In some examples, aspects of the operations of 2410 may be performed by an access link communications manager 1140 as described with reference to FIG. 11.

At 2415, the method may include transmitting, to the aerial UE and one or more other UEs, a resource allocation for a set of sidelink resources for A2X communications. The operations of block 2415 may be performed in accordance with examples as disclosed herein. In some examples, aspects of the operations of 2415 may be performed by a sidelink resource manager 1130 as described with reference to FIG. 11.

The following provides an overview of aspects of the present disclosure:

Aspect 1: A method for wireless communication by a UE, comprising: transmitting a capability indication of the UE, wherein the capability indication indicates one or more supported functions for that use A2X communication via a sidelink connection of the UE; and transmitting or receiving one or more A2X transmissions using at least a subset of a resource allocation that is determined from a set of sidelink resources for A2X communications.

Aspect 2: The method of aspect 1, wherein transmitting the capability indication comprises: transmitting a set of supported A2X parameters that are separate from a different set of V2X communication parameters for sidelink communications.

Aspect 3: The method of any of aspects 1 through 2, further comprising: transmitting a capability indication for sidelink communications, wherein the A2X communication is dependent on support of sidelink communications at the UE.

Aspect 4: The method of any of aspects 1 through 2, wherein transmitting the capability indication comprises: transmitting one or more A2X capability parameters that indicate support for one or more of BRID communications or DAA communications.

Aspect 5: The method of any of aspects 1 through 4, wherein transmitting the capability indication comprises: transmitting a capability indication for a subset of sidelink communications, that indicates the UE supports less than all sidelink communication capabilities.

Aspect 6: The method of aspect 5, wherein the capability indication indicates the UE supports receive-only functions of A2X communications.

Aspect 7: The method of aspect 5, wherein the capability indication indicates the UE supports transmit-only functions of A2X communications.

Aspect 8: The method of aspect 5, wherein the capability indication indicates the UE supports channel sensing for a sidelink channel, and supports transmit-only functions of A2X communications.

Aspect 9: The method of any of aspects 1 through 8, wherein the capability indication is provided in one or more A2X capability bits that are appended to one or more sidelink capability messages.

Aspect 10: The method of any of aspects 1 through 9, wherein transmitting the capability indication comprises: transmitting the capability indication as a differential capability from an associated V2X communication capability.

Aspect 11: The method of any of aspects 1 through 10, wherein the capability indication includes separate indications of support for BRID communications and DAA communications.

Aspect 12: The method of any of aspects 1 through 11, wherein the capability indication includes a single indication of support for BRID communications and DAA communications.

Aspect 13: The method of any of aspects 1 through 12, further comprising: transmitting an indication to a network entity of one or more supported UE functions using an access link with the network entity.

Aspect 14: The method of aspect 13, wherein the one or more supported UE functions include one or more of height-dependent parameter reporting, joint measurement and height-dependent parameter reporting, flight path parameter reporting, or any combinations thereof.

Aspect 15: A method for wireless communication by a UE, comprising: receiving a capability indication from an aerial UE, wherein the capability indication indicates one or more supported functions that useA2X communication of the aerial UE; and transmitting or receiving one or more A2X transmissions using at least a subset of a resource allocation of sidelink resources for A2X communications.

Aspect 16: The method of aspect 15, wherein the capability indication indicates a set of supported A2X parameters that are separate from a different set of V2X communication parameters for sidelink communications, that are independent of V2X communications parameters, that are dependent on one or more V2X communications parameters, that indicates the aerial UE supports less than all V2X communication capabilities, that indicates the aerial UE supports receive-only functions of A2X communications, that indicates the aerial UE supports transmit-only functions of A2X communications, or that indicates the aerial UE supports only channel sensing receptions for a sidelink channel.

Aspect 17: The method of any of aspects 15 through 16, wherein the capability indication is provided in one or more A2X capability bits that are appended to one or more sidelink capability messages.

Aspect 18: The method of any of aspects 15 through 17, wherein the capability indication is a differential capability from an associated V2X communication capability.

Aspect 19: The method of any of aspects 15 through 18, wherein the capability indication includes separate indications of support for BRID communications and DAA communications.

Aspect 20: The method of any of aspects 15 through 19, wherein the capability indication includes a single indication of support for BRID communications and DAA communications.

Aspect 21: A method for wireless communication by a network entity, comprising: receiving a capability indication from an aerial UE, where the capability indication indicates one or more supported functions for one or more of BRID communications or DAA communications using A2X communication of the aerial UE; and transmitting, to the aerial UE and one or more other UEs, a resource allocation for a set of sidelink resources for A2X communications.

Aspect 22: The method of aspect 21, wherein receiving the capability indication comprises: receiving, from the aerial UE, a set of supported A2X parameters that are separate from a different set of V2X communication parameters for sidelink communications.

Aspect 23: The method of any of aspects 21 through 22, further comprising: receiving, from the aerial UE, a capability indication for sidelink communications, wherein the A2X communication is dependent on support of sidelink communications at the aerial UE.

Aspect 24: The method of any of aspects 21 through 23, wherein receiving the capability indication comprises: receiving, from the aerial UE, one or more A2X capability parameters that indicate support for one or more of BRID communications or DAA communications.

Aspect 25: The method of any of aspects 21 through 24, wherein receiving the capability indication comprises: receiving, from the aerial UE, a capability indication for a subset of sidelink communications, that indicates the aerial UE supports less than all sidelink communication capabilities.

Aspect 26: The method of aspect 25, wherein the capability indication indicates the aerial UE supports receive-only functions of A2X communications.

Aspect 27: The method of any of aspects 25 through 26, wherein the capability indication indicates the aerial UE supports transmit-only functions of A2X communications.

Aspect 28: The method of any of aspects 25 through 27, wherein the capability indication indicates the aerial UE supports channel sensing for a sidelink channel, and supports transmit-only functions of A2X communications.

Aspect 29: The method of any of aspects 21 through 28, wherein the capability indication is provided in one or more A2X capability bits that are appended to one or more sidelink capability messages.

Aspect 30: The method of any of aspects 21 through 29, wherein receiving the capability indication comprises: receiving, from the aerial UE, the capability indication as a differential capability from an associated V2X communication capability.

Aspect 31: The method of any of aspects 21 through 30, wherein the capability indication includes separate indications of support for BRID communications and DAA communications.

Aspect 32: The method of any of aspects 21 through 31, wherein the capability indication includes a single indication of support for BRID communications and DAA communications.

Aspect 33: The method of any of aspects 21 through 32, further comprising: receiving, from the aerial UE, an indication of one or more supported aerial UE functions that use an access link with the network entity.

Aspect 34: The method of aspect 33, wherein the one or more aerial UE functions include one or more of height-dependent parameter reporting, joint measurement and height-dependent parameter reporting, flight path parameter reporting, or any combinations thereof.

Aspect 35: A UE for wireless communication, comprising one or more memories storing processor-executable code, and one or more processors coupled with the one or more memories and individually or collectively operable to execute the code to cause the aerial UE to perform a method of any of aspects 1 through 14.

Aspect 36: A UE for wireless communication, comprising at least one means for performing a method of any of aspects 1 through 14.

Aspect 37: A non-transitory computer-readable medium storing code for wireless communication, the code comprising instructions executable by a processor to perform a method of any of aspects 1 through 14.

Aspect 38: A UE for wireless communication, comprising one or more memories storing processor-executable code, and one or more processors coupled with the one or more memories and individually or collectively operable to execute the code to cause the UE to perform a method of any of aspects 15 through 20.

Aspect 39: A UE for wireless communication, comprising at least one means for performing a method of any of aspects 15 through 20.

Aspect 40: A non-transitory computer-readable medium storing code for wireless communication, the code comprising instructions executable by a processor to perform a method of any of aspects 15 through 20.

Aspect 41: A network entity for wireless communication, comprising one or more memories storing processor-executable code, and one or more processors coupled with the one or more memories and individually or collectively operable to execute the code to cause the network entity to perform a method of any of aspects 21 through 34.

Aspect 42: A network entity for wireless communication, comprising at least one means for performing a method of any of aspects 21 through 34.

Aspect 43: A non-transitory computer-readable medium storing code for wireless communication, the code comprising instructions executable by a processor to perform a method of any of aspects 21 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability indication of the UE, wherein the capability indication indicates one or more supported functions that use aircraft-to-everything communication via a sidelink connection of the UE; and
transmit or receive one or more aircraft-to-everything transmissions using at least a subset of a resource allocation that is determined from a set of sidelink resources for aircraft-to-everything communication.

2. The UE of claim 1, wherein, to transmit the capability indication, the one or more processors are individually or collectively operable to execute the code to cause the UE to:
transmit a set of supported aircraft-to-everything parameters that are separate from a different set of vehicle-to-everything communication parameters for sidelink communications.

3. The UE of claim 1, wherein the one or more processors are individually or collectively further operable to execute the code to cause the UE to:
transmit a capability indication for sidelink communications, wherein the aircraft-to-everything communication is dependent on support of sidelink communication at the UE.

4. The UE of claim 1, wherein, to transmit the capability indication, the one or more processors are individually or collectively operable to execute the code to cause the UE to:
transmit one or more aircraft-to-everything capability parameters that indicate support for one or more of broadcast remote identification communications or detect-and-avoid communications, or other A2X services.

5. The UE of claim 1, wherein, to transmit the capability indication, the one or more processors are individually or collectively operable to execute the code to cause the UE to:
transmit a capability indication for a subset of sidelink communications, that indicates the UE supports less than all sidelink communication capabilities.

6. The UE of claim 5, wherein the capability indication indicates the UE supports receive-only functions of aircraft-to-everything communication.

7. The UE of claim 5, wherein the capability indication indicates the UE supports transmit-only functions of aircraft-to-everything communication.

8. The UE of claim 5, wherein the capability indication indicates the UE supports channel sensing for a sidelink channel, and supports transmit-only functions of aircraft-to-everything communication.

9. The UE of claim 1, wherein:
the capability indication is provided in one or more aircraft-to-everything capability bits that are appended to one or more sidelink capability messages.

10. The UE of claim 1, wherein, to transmit the capability indication, the one or more processors are individually or collectively operable to execute the code to cause the UE to:
transmit the capability indication as a differential capability from an associated vehicle-to-everything communication capability.

11. The UE of claim 1, wherein:
the capability indication includes separate indications of support for broadcast remote identification communications and detect-and-avoid communications.

12. The UE of claim 1, wherein the capability indication includes a single indication of support for broadcast remote identification communications and/or detect-and-avoid communications.

13. The UE of claim 12, wherein the single indication comprises a two-bit field that indicates support for broadcast remote identification communications, detect-and-avoid communications, or both.

14. The UE of claim 1, wherein the one or more processors are individually or collectively further operable to execute the code to cause the UE to:
transmit a second capability indication to a network entity, wherein the second capability indication indicates one or more supported UE functions using an access link with the network entity.

15. The UE of claim 14, wherein the one or more supported UE functions include one or more of height-dependent parameter reporting, joint measurement and height-dependent parameter reporting, flight path parameter reporting, or any combinations thereof.

16. The UE of claim 1, wherein the one or more aircraft-to-everything transmissions comprise one or more of a broadcast remote identification transmission or a detect and avoid transmission.

17. The UE of claim 1, wherein the capability indication indicates a list of one or more aircraft-to-everything sidelink bands or sidelink band combinations where one or more aircraft-to-everything services are supported by the UE.

18. A method for wireless communication by a user equipment (UE), comprising:
transmitting a capability indication of the UE, wherein the capability indication indicates one or more supported functions that use aircraft-to-everything communication via a sidelink connection of the UE; and
transmitting or receiving one or more aircraft-to-everything transmissions using at least a subset of a resource allocation that is determined from a set of sidelink resources for aircraft-to-everything communications.

19. The method of claim 18, wherein transmitting the capability indication comprises:
transmitting a set of supported aircraft-to-everything parameters that are separate from a different set of vehicle-to-everything communication parameters for sidelink communication.

20. A non-transitory computer-readable medium storing code for wireless communication at a user equipment (UE), the code comprising instructions executable by one or more processors to:
transmit a capability indication of the UE, wherein the capability indication indicates one or more supported functions that use aircraft-to-everything communication via a sidelink connection of the UE; and
transmit or receive one or more aircraft-to-everything transmissions using at least a subset of a resource allocation that is determined from a set of sidelink resources for aircraft-to-everything communication.
